(19) United States
(12) Patent Application Publication
(10) Pub. No.: US 2026/0303295 A1
(43) Pub. Date: Oct. 1, 2026

(54) TRANSMISSION OF REFERENCE SIGNAL CONFIGURATION IN BROADCAST MESSAGES FOR IDLE AND INACTIVE USER EQUIPMENT

(71) Applicant: QUALCOMM Incorporated, San Diego, CA (US)

(72) Inventors: Huilin XU, Temecula, CA (US); Ozcan OZTURK, San Diego, CA (US); Yuchul KIM, San Diego, CA (US); Xipeng ZHU, San Diego, CA (US); Chenxi HAO, Beijing (CN); Jing LEI, San Diego, CA (US); Wanshi CHEN, San Diego, CA (US); Hwan Joon KWON, San Diego, CA (US)

(21) Appl. No.: 19/705,588

(22) Filed: Jun. 11, 2026

Related U.S. Application Data
(63) Continuation of application No. 18/042,760, filed on Oct. 21, 2020.

(51) Int. Cl. H04L 5/00; H04W 68/02; H04W 72/1273; H04W 72/232

(52) U.S. Cl. CPC H04L 5/0051; H04W 68/02; H04W 72/1273; H04W 72/232

(57) ABSTRACT

Methods, systems, and devices for wireless communications are described. The method may include receiving, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receiving, while operating in the first mode, one or more reference signals from the base station in accordance with the reference signal configuration, and determining one or more channel measurements based on the one or more reference signals received from the base station.

### CROSS REFERENCE

The present Application for Patent is a continuation of U.S. patent application Ser. No. 18/042,760 by XU et al., entitled “TRANSMISSION OF REFERENCE SIGNAL CONFIGURATION IN BROADCAST MESSAGES FOR IDLE AND INACTIVE USER EQUIPMENT,” filed Feb. 23, 2023, which claims priority to and the benefit of International PCT Application No. PCT/CN2020/122462 by XU et al. entitled “TRANSMISSION OF REFERENCE SIGNAL CONFIGURATION IN BROADCAST MESSAGES FOR IDLE AND INACTIVE USER EQUIPMENT,” filed Oct. 21, 2020, each of which is assigned to the assignee hereof and expressly incorporated by reference in its entirety herein.

### FIELD OF TECHNOLOGY

The following relates to wireless communications, including transmission of reference signal configuration in broadcast messages for idle and inactive user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless systems may support the transmission of UE-specific transmissions to a user equipment (UE). However, improvements in the transmission of UE-specific transmissions to UEs may be desirable.

### SUMMARY

The described techniques relate to improved methods, systems, devices, and apparatuses that support transmission of reference signal configuration in broadcast messages for idle and inactive user equipment. Generally, the described techniques provide for a user equipment (UE) receiving, from a base station while the UE is operating in either an idle mode or an inactive mode, a broadcast transmission that includes a reference signal configuration for communications between the base station and the UE. In some cases, the reference signal configuration may indicate one or more reference signal parameters. The UE may receive, while operating in either the idle mode or the inactive mode, one or more reference signals from the base station in accordance with the reference signal configuration. In some cases, the UE may determine one or more channel measurements based at least in part on the one or more reference signals received from the base station.

A method of wireless communication at a UE is described. The method may include receiving, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receiving, while operating in the first mode, one or more reference signals from the base station in accordance with the reference signal configuration, and determining one or more channel measurements based on the one or more reference signals received from the base station.

An apparatus for wireless communication at a UE is described. The apparatus may include a processor, memory coupled with the processor, and instructions stored in the memory. The instructions may be executable by the processor to cause the apparatus to receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receive, while operating in the first mode, one or more reference signals from the base station in accordance with the reference signal configuration, and determine one or more channel measurements based on the one or more reference signals received from the base station.

Another apparatus for wireless communication at a UE is described. The apparatus may include means for receiving, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receiving, while operating in the first mode, one or more reference signals from the base station in accordance with the reference signal configuration, and determining one or more channel measurements based on the one or more reference signals received from the base station.

A non-transitory computer-readable medium storing code for wireless communication at a UE is described. The code may include instructions executable by a processor to receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receive, while operating in the first mode, one or more reference signals from the base station in accordance with the reference signal configuration, and determine one or more channel measurements based on the one or more reference signals received from the base station.

In some examples of the method, apparatuses, and non-transitory computer-readable medium described herein, receiving the broadcast transmission that includes the reference signal configuration may include operations, features, means, or instructions for receiving the reference signal configuration in one or more system information blocks.

Some examples of the method, apparatuses, and non-transitory computer-readable medium described herein may further include operations, features, means, or instructions for periodically receiving, based on scheduling information indicated in a type 1 system information block received by the UE, the one or more system information blocks when a type of the one or more system information blocks does not include the type 1 system information block.

In some examples of the method, apparatuses, and non-transitory computer-readable medium described herein, the one or more system information blocks include a type 1 system information block when the one or more reference signals may be configured for a serving cell.

In some examples of the method, apparatuses, and non-transitory computer-readable medium described herein, the one or more system information blocks include a type 2 system information block or a type 3 system information block, or both, when the one or more reference signals may be configured for an intra-frequency neighbor cell.

In some examples of the method, apparatuses, and non-transitory computer-readable medium described herein, the one or more system information blocks include a type 4 system information block or a type 5 system information block, or both, when the one or more reference signals may be configured for an inter-frequency neighbor cell.

Some examples of the method, apparatuses, and non-transitory computer-readable medium described herein may further include operations, features, means, or instructions for receiving an update to the reference signal configuration in one or more system information blocks, where the update to the reference signal configuration may be indicated by one or more bits of a paging downlink control information.

Some examples of the method, apparatuses, and non-transitory computer-readable medium described herein may further include operations, features, means, or instructions for determining that the reference signal configuration may be updated based on a system information modification bit of a short message of the paging downlink control information.

Some examples of the method, apparatuses, and non-transitory computer-readable medium described herein may further include operations, features, means, or instructions for determining that the reference signal configuration may be updated based on a bit of a set of unused bits of a short message of the paging downlink control information.

Some examples of the method, apparatuses, and non-transitory computer-readable medium described herein may further include operations, features, means, or instructions for receiving, in a physical downlink control channel, an indication of an availability of the reference signal or an indication of an update to the reference signal configuration, where the availability or the update may be indicated by one or more bits of a paging downlink control information.

Some examples of the method, apparatuses, and non-transitory computer-readable medium described herein may further include operations, features, means, or instructions for determining that the one or more bits of the paging downlink control information indicate the reference signal may be available to the UE or that there may be an update to the reference signal configuration.

In some examples of the method, apparatuses, and non-transitory computer-readable medium described herein, a set of unused bits of the paging downlink control information, or a set of reserved bits of the paging downlink control information, or both, include the one or more bits of the paging downlink control information.

In some examples of the method, apparatuses, and non-transitory computer-readable medium described herein, the paging downlink control information may be associated with physical downlink shared channel scheduling information.

Some examples of the method, apparatuses, and non-transitory computer-readable medium described herein may further include operations, features, means, or instructions for determining that the one or more bits of the paging downlink control information includes a first bit to indicate whether the reference signal may be available to the UE in the physical downlink control channel, or a second bit to indicate whether there may be an update to the reference signal configuration, or both.

In some examples of the method, apparatuses, and non-transitory computer-readable medium described herein, the one or more bits of the paging downlink control information include one indication per reference signal resource of the reference signal configuration.

In some examples of the method, apparatuses, and non-transitory computer-readable medium described herein, the one or more bits of the paging downlink control information include one indication per group of reference signal resources of the reference signal configuration.

In some examples of the method, apparatuses, and non-transitory computer-readable medium described herein, the one or more bits of the paging downlink control information include one indication per reference signal resource set of the reference signal configuration.

In some examples of the method, apparatuses, and non-transitory computer-readable medium described herein, the one or more bits of the paging downlink control information include one indication per group of reference signal resource sets of the reference signal configuration.

Some examples of the method, apparatuses, and non-transitory computer-readable medium described herein may further include operations, features, means, or instructions for determining an identifier for each reference signal resource, each reference signal resource set, each group of reference signal resources or each group of reference signal resource sets from a smallest identifier to a largest identifier, and mapping the reference signal resources, reference signal resource sets, reference signal resource groups, or reference signal resource set groups to the one or more bits in order from the smallest identifier to the largest identifier, where a reference signal resource, reference signal resource set, reference signal resource group, or reference signal resource set group with the smallest identifier may be mapped to a least significant bit of the one or more bits and a reference signal resource, reference signal resource set, reference signal resource group or reference signal resource set group with the largest identifier may be mapped to a most significant bit of the one or more bits.

Some examples of the method, apparatuses, and non-transitory computer-readable medium described herein may further include operations, features, means, or instructions for receiving, in a paging indicator of a physical downlink control channel, an indication of availability of the reference signal or an indication of an update to the reference signal configuration.

In some examples of the method, apparatuses, and non-transitory computer-readable medium described herein, the physical downlink control channel carries information for at least one group of UEs associated with a paging occasion.

Some examples of the method, apparatuses, and non-transitory computer-readable medium described herein may further include operations, features, means, or instructions for identifying a dynamic indication field of the physical downlink control channel, where the dynamic indication field indicates that a group of UEs of the at least one group of UEs may be paged in a next paging occasion, the group of UEs including the UE.

Some examples of the method, apparatuses, and non-transitory computer-readable medium described herein may further include operations, features, means, or instructions for identifying a content field of the physical downlink control channel, where a first bit of the content field indicates whether the UE may be paged in a next paging occasion and remaining bits of the content field includes the indication of the availability of the reference signal or the indication of the update to the reference signal configuration.

Some examples of the method, apparatuses, and non-transitory computer-readable medium described herein may further include operations, features, means, or instructions for receiving an indication of an availability of the reference signal or an indication of an update to the reference signal configuration in one or more reference signal sequences.

In some examples of the method, apparatuses, and non-transitory computer-readable medium described herein, the reference signal configuration may be encoded when at least one reference signal sequence of the one or more reference signal sequences may be generated.

Some examples of the method, apparatuses, and non-transitory computer-readable medium described herein may further include operations, features, means, or instructions for determining an availability of the one or more reference signals based on the one or more reference signal sequences.

Some examples of the method, apparatuses, and non-transitory computer-readable medium described herein may further include operations, features, means, or instructions for receiving a first reference signal sequence of the one or more reference signal sequences indicates that the one or more reference signals remain available, receiving a second reference signal sequence of the one or more reference signal sequences and different from the first reference signal sequence indicates that the one or more reference signals do not remain available, and receiving neither the first reference signal sequence nor the second reference signal sequence indicates that the UE may be not being paged in a next paging occasion.

Some examples of the method, apparatuses, and non-transitory computer-readable medium described herein may further include operations, features, means, or instructions for receiving the reference signal configuration or an update to the reference signal configuration in a physical downlink shared channel.

Some examples of the method, apparatuses, and non-transitory computer-readable medium described herein may further include operations, features, means, or instructions for determining one or more bits of a set of unused bits of a short message of a paging downlink control information indicates that the physical downlink shared channel includes the reference signal configuration or the update to the reference signal configuration.

Some examples of the method, apparatuses, and non-transitory computer-readable medium described herein may further include operations, features, means, or instructions for determining one or more bits of a set of reserved bits of a paging downlink control information indicates that the physical downlink shared channel includes the reference signal configuration or the update to the reference signal configuration.

Some examples of the method, apparatuses, and non-transitory computer-readable medium described herein may further include operations, features, means, or instructions for receiving the reference signal configuration or an update to the reference signal configuration in a nonCriticalExtension of a paging message, where pagingRecordList may be not included in the paging message.

Some examples of the method, apparatuses, and non-transitory computer-readable medium described herein may further include operations, features, means, or instructions for receiving a second reference signal configuration in a physical downlink shared channel after receiving the reference signal configuration, and overwriting the reference signal configuration in memory with the second reference signal configuration based on receiving the second reference signal configuration in the physical downlink shared channel.

Some examples of the method, apparatuses, and non-transitory computer-readable medium described herein may further include operations, features, means, or instructions for receiving an update to the reference signal configuration in a physical downlink shared channel and, and updating at least a portion of the reference signal configuration in memory based on receiving the update to the reference signal configuration in the physical downlink shared channel.

Some examples of the method, apparatuses, and non-transitory computer-readable medium described herein may further include operations, features, means, or instructions for identifying a channel state information resource configuration in the reference signal configuration.

Some examples of the method, apparatuses, and non-transitory computer-readable medium described herein may further include operations, features, means, or instructions for identifying channel state information resources for resource identifiers linked to a resource set provided in the reference signal configuration, where the channel state information resources may be quasi co-located to one or more synchronization signal blocks.

A method of wireless communication at a base station is described. The method may include generating a reference signal configuration for communications between the base station and a UE operating in a first mode, the reference signal configuration indicating one or more reference signal parameters and the first mode being either an idle mode or an inactive mode, transmitting, to the UE, a broadcast transmission that includes the reference signal configuration, transmitting, to the UE while the UE is operating in the first mode, one or more reference signals in accordance with the reference signal configuration, and receiving, from the UE, one or more channel measurements based on the one or more reference signals transmitted to the UE.

An apparatus for wireless communication at a base station is described. The apparatus may include a processor, memory coupled with the processor, and instructions stored in the memory. The instructions may be executable by the processor to cause the apparatus to generate a reference signal configuration for communications between the base station and a UE operating in a first mode, the reference signal configuration indicating one or more reference signal parameters and the first mode being either an idle mode or an inactive mode, transmit, to the UE, a broadcast transmission that includes the reference signal configuration, transmit, to the UE while the UE is operating in the first mode, one or more reference signals in accordance with the reference signal configuration, and receive, from the UE, one or more channel measurements based on the one or more reference signals transmitted to the UE.

Another apparatus for wireless communication at a base station is described. The apparatus may include means for generating a reference signal configuration for communications between the base station and a UE operating in a first mode, the reference signal configuration indicating one or more reference signal parameters and the first mode being either an idle mode or an inactive mode, transmitting, to the UE, a broadcast transmission that includes the reference signal configuration, transmitting, to the UE while the UE is operating in the first mode, one or more reference signals in accordance with the reference signal configuration, and receiving, from the UE, one or more channel measurements based on the one or more reference signals transmitted to the UE.

A non-transitory computer-readable medium storing code for wireless communication at a base station is described. The code may include instructions executable by a processor to generate a reference signal configuration for communications between the base station and a UE operating in a first mode, the reference signal configuration indicating one or more reference signal parameters and the first mode being either an idle mode or an inactive mode, transmit, to the UE, a broadcast transmission that includes the reference signal configuration, transmit, to the UE while the UE is operating in the first mode, one or more reference signals in accordance with the reference signal configuration, and receive, from the UE, one or more channel measurements based on the one or more reference signals transmitted to the UE.

In some examples of the method, apparatuses, and non-transitory computer-readable medium described herein, transmitting the broadcast transmission that includes the reference signal configuration may include operations, features, means, or instructions for transmitting the reference signal configuration in one or more system information blocks.

Some examples of the method, apparatuses, and non-transitory computer-readable medium described herein may further include operations, features, means, or instructions for periodically transmitting, based on scheduling information indicated in a type 1 system information block transmitted to the UE by the base station, the one or more system information blocks when a type of the one or more system information blocks does not include the type 1 system information block.

In some examples of the method, apparatuses, and non-transitory computer-readable medium described herein, the one or more system information blocks include a type 1 system information block when the one or more reference signals may be configured for a serving cell.

In some examples of the method, apparatuses, and non-transitory computer-readable medium described herein, the one or more system information blocks include a type 2 system information block or a type 3 system information block, or both, when the one or more reference signals may be configured for an intra-frequency neighbor cell.

In some examples of the method, apparatuses, and non-transitory computer-readable medium described herein, the one or more system information blocks include a type 4 system information block or a type 5 system information block, or both, when the one or more reference signals may be configured for an inter-frequency neighbor cell.

Some examples of the method, apparatuses, and non-transitory computer-readable medium described herein may further include operations, features, means, or instructions for transmitting an update to the reference signal configuration in one or more system information blocks, where the update to the reference signal configuration may be indicated by one or more bits of a paging downlink control information.

Some examples of the method, apparatuses, and non-transitory computer-readable medium described herein may further include operations, features, means, or instructions for indicating that the reference signal configuration may be updated based on a system information modification bit of a short message of the paging downlink control information.

Some examples of the method, apparatuses, and non-transitory computer-readable medium described herein may further include operations, features, means, or instructions for indicating that the reference signal configuration may be updated based on a bit of a set of unused bits of a short message of the paging downlink control information.

Some examples of the method, apparatuses, and non-transitory computer-readable medium described herein may further include operations, features, means, or instructions for transmitting, in a physical downlink control channel, an indication of an availability of the reference signal or an indication of an update to the reference signal configuration, where the availability or the update may be indicated by one or more bits of a paging downlink control information.

Some examples of the method, apparatuses, and non-transitory computer-readable medium described herein may further include operations, features, means, or instructions for indicating in the one or more bits of the paging downlink control information that the reference signal may be available to the UE or that there may be an update to the reference signal configuration.

In some examples of the method, apparatuses, and non-transitory computer-readable medium described herein, a set of unused bits of the paging downlink control information, or a set of reserved bits of the paging downlink control information, or both, include the one or more bits of the paging downlink control information.

In some examples of the method, apparatuses, and non-transitory computer-readable medium described herein, the paging downlink control information may be associated with physical downlink shared channel scheduling information.

Some examples of the method, apparatuses, and non-transitory computer-readable medium described herein may further include operations, features, means, or instructions for configuring a first bit of the one or more bits of the paging downlink control information to indicate whether the reference signal may be available to the UE in the physical downlink control channel, or a second bit of the one or more bits of the paging downlink control information to indicate whether there may be an update to the reference signal configuration, or configuring both.

Some examples of the method, apparatuses, and non-transitory computer-readable medium described herein may further include operations, features, means, or instructions for configuring the one or more bits of the paging downlink control information to include one indication per reference signal resource of the reference signal configuration.

Some examples of the method, apparatuses, and non-transitory computer-readable medium described herein may further include operations, features, means, or instructions for configuring the one or more bits of the paging downlink control information to include one indication per group of reference signal resources of the reference signal configuration.

Some examples of the method, apparatuses, and non-transitory computer-readable medium described herein may further include operations, features, means, or instructions for configuring the one or more bits of the paging downlink control information to include one indication per reference signal resource set of the reference signal configuration.

Some examples of the method, apparatuses, and non-transitory computer-readable medium described herein may further include operations, features, means, or instructions for configuring the one or more bits of the paging downlink control information to include one indication per group of reference signal resource sets of the reference signal configuration.

Some examples of the method, apparatuses, and non-transitory computer-readable medium described herein may further include operations, features, means, or instructions for determining an identifier for each reference signal resource, each reference signal resource set, each group of reference signal resources, or each group of reference signal resource sets from a smallest identifier to a largest identifier, and mapping the reference signal resources, reference signal resource sets, reference signal resource groups or reference signal resource set groups to the one or more bits in order from the smallest identifier to the largest identifier, where a reference signal resource, reference signal resource set, reference signal resource group or reference signal resource set group with the smallest identifier may be mapped to a least significant bit of the one or more bits and a reference signal resource, reference signal resource set, reference signal resource group or reference signal resource set group with the largest identifier may be mapped to a most significant bit of the one or more bits.

Some examples of the method, apparatuses, and non-transitory computer-readable medium described herein may further include operations, features, means, or instructions for transmitting, in a paging indicator of a physical downlink control channel, an indication of an availability of the reference signal or an indication of an update to the reference signal configuration.

In some examples of the method, apparatuses, and non-transitory computer-readable medium described herein, the physical downlink control channel carries information for at least one group of UEs associated with a paging occasion.

Some examples of the method, apparatuses, and non-transitory computer-readable medium described herein may further include operations, features, means, or instructions for identifying a dynamic indication field of the physical downlink control channel, where the dynamic indication field indicates that a group of UEs of the at least one group of UEs may be paged in a next paging occasion, the group of UEs including the UE.

Some examples of the method, apparatuses, and non-transitory computer-readable medium described herein may further include operations, features, means, or instructions for configuring a first bit of a content field of the physical downlink control channel to indicate whether the UE may be paged in a next paging occasion and remaining bits of the content field to include an indication of the availability of the reference signal or an indication of the update to the reference signal configuration.

Some examples of the method, apparatuses, and non-transitory computer-readable medium described herein may further include operations, features, means, or instructions for transmitting, in one or more reference signal sequences, an indication of an availability of the reference signal or an indication of an update to the reference signal configuration.

Some examples of the method, apparatuses, and non-transitory computer-readable medium described herein may further include operations, features, means, or instructions for encoding the reference signal configuration when at least one reference signal sequence of the one or more reference signal sequences may be generated.

Some examples of the method, apparatuses, and non-transitory computer-readable medium described herein may further include operations, features, means, or instructions for indicating an availability of the one or more reference signals based on the one or more reference signal sequences.

Some examples of the method, apparatuses, and non-transitory computer-readable medium described herein may further include operations, features, means, or instructions for transmitting a first reference signal sequence of the one or more reference signal sequences indicates that the one or more reference signals remain available, transmitting a second reference signal sequence of the one or more reference signal sequences and different from the first reference signal sequence indicates that the one or more reference signals do not remain available, and transmitting neither the first reference signal sequence nor the second reference signal sequence indicates that the UE may be not being paged in a next paging occasion.

Some examples of the method, apparatuses, and non-transitory computer-readable medium described herein may further include operations, features, means, or instructions for transmitting the reference signal configuration or an update to the reference signal configuration in a physical downlink shared channel.

Some examples of the method, apparatuses, and non-transitory computer-readable medium described herein may further include operations, features, means, or instructions for configuring one or more bits of a set of unused bits of a short message of a paging downlink control information to indicate that the physical downlink shared channel includes the reference signal configuration or the update to the reference signal configuration.

Some examples of the method, apparatuses, and non-transitory computer-readable medium described herein may further include operations, features, means, or instructions for configuring one or more bits of a set of reserved bits of a paging downlink control information to indicate that the physical downlink shared channel includes the reference signal configuration or the update to the reference signal configuration.

Some examples of the method, apparatuses, and non-transitory computer-readable medium described herein may further include operations, features, means, or instructions for transmitting the reference signal configuration or an update to the reference signal configuration in a nonCriticalExtension of a paging message, where pagingRecordList may be not included in the paging message.

Some examples of the method, apparatuses, and non-transitory computer-readable medium described herein may further include operations, features, means, or instructions for transmitting a second reference signal configuration in a physical downlink shared channel after transmitting the reference signal configuration, where the UE may be configured to overwrite the reference signal configuration in memory with the second reference signal configuration based on the UE receiving the second reference signal configuration in the physical downlink shared channel.

Some examples of the method, apparatuses, and non-transitory computer-readable medium described herein may further include operations, features, means, or instructions for transmitting an update to the reference signal configuration in a physical downlink shared channel, where the UE may be configured to update at least a portion of the reference signal configuration in memory based on the UE receiving the update to the reference signal configuration in the physical downlink shared channel.

Some examples of the method, apparatuses, and non-transitory computer-readable medium described herein may further include operations, features, means, or instructions for configuring the reference signal configuration to include a channel state information resource configuration.

Some examples of the method, apparatuses, and non-transitory computer-readable medium described herein may further include operations, features, means, or instructions for configuring the reference signal configuration to include channel state information resources for a resource identifier linked to a resource set, where the channel state information resources may be quasi co-located to one or more synchronization signal blocks.

### BRIEF DESCRIPTION OF THE DRAWINGS

FIG. 1 illustrates an example of a system for wireless communications that supports transmission of reference signal configuration in broadcast messages for idle and inactive user equipment in accordance with aspects of the present disclosure.

FIG. 2 illustrates an example of a wireless communications subsystem that supports transmission of reference signal configuration in broadcast messages for idle and inactive user equipment in accordance with aspects of the present disclosure.

FIG. 3 illustrates an example of an environment that supports transmission of reference signal configuration in broadcast messages for idle and inactive user equipment in accordance with aspects of the present disclosure.

FIG. 4 illustrates an example of a process flow that supports transmission of reference signal configuration in broadcast messages for idle and inactive user equipment in accordance with aspects of the present disclosure.

FIGS. 5 and 6 show block diagrams of devices that support transmission of reference signal configuration in broadcast messages for idle and inactive user equipment in accordance with aspects of the present disclosure.

FIG. 7 shows a block diagram of a communications manager that supports transmission of reference signal configuration in broadcast messages for idle and inactive user equipment in accordance with aspects of the present disclosure.

FIG. 8 shows a diagram of a system including a device that supports transmission of reference signal configuration in broadcast messages for idle and inactive user equipment in accordance with aspects of the present disclosure.

FIGS. 9 and 10 show block diagrams of devices that support transmission of reference signal configuration in broadcast messages for idle and inactive user equipment in accordance with aspects of the present disclosure.

FIG. 11 shows a block diagram of a communications manager that supports transmission of reference signal configuration in broadcast messages for idle and inactive user equipment in accordance with aspects of the present disclosure.

FIG. 12 shows a diagram of a system including a device that supports transmission of reference signal configuration in broadcast messages for idle and inactive user equipment in accordance with aspects of the present disclosure.

FIGS. 13 through 20 show flowcharts illustrating methods that support transmission of reference signal configuration in broadcast messages for idle and inactive user equipment in accordance with aspects of the present disclosure.

### DETAILED DESCRIPTION

Some wireless communications systems, such as 4G, 5G, and new radio (NR) systems, may support the transmission of user equipment (UE)-specific transmissions to one or more UEs. The present techniques include transmission of reference signal configuration in broadcast messages for UEs operating in an idle and inactive mode. In some cases, a base station may transmit UE-specific transmissions to a UE when the UE is in a connected mode or active mode and the UE may respond with channel measurements, etc., without any issues. However, when the UE is in an idle mode or inactive mode, the UE may not be configured or capable of receiving the UE-specific transmissions that the UE is configured to receive in connected mode or active mode.

The present techniques include supporting transmission of UE-specific transmissions to a UE when the UE is in an idle mode or inactive mode. When the UE is in an idle mode or inactive mode, the UE may be configured to receive broadcast messages or group cast messages. The present techniques may include providing UE-specific transmissions in broadcast messages or group cast messages to enable the UE to receive and process UE-specific transmissions while the UE is in the idle mode or inactive mode. In some cases, the UE-specific transmissions may include a resource signal configuration. In some cases, the base station may transmit a resource signal configuration or an indication of a resource signal configuration in a system information block, or a physical downlink control channel, or a physical downlink shared channel, or any combination thereof. In some cases, the base station may broadcast or group cast a full resource signal configuration, or a partial resource signal configuration, or an indicator of a resource signal configuration, or any combination thereof. The indicator of a resource signal configuration may indicate a resource signal configuration is available or unavailable. In some cases, the indicator of a resource signal configuration may indicate a resource signal configuration is updated or is not updated, or that an update to a resource signal configuration is available or that an update to a resource signal configuration is not available.

Aspects of the subject matter described herein may be implemented to realize one or more advantages. The described techniques may support improvements in system efficiency that enable and configure a UE to perform channel measurements while in an inactive or idle mode. Additionally, the described techniques may result in improving user experience, avoiding multiple retransmissions and failed transmissions, decreasing system latency, improving the reliability of channel measurements whether the UE is operating in a connected or active mode, or the UE is operating in an inactive or idle mode.

Aspects of the disclosure are initially described in the context of wireless communications systems. Aspects of the disclosure are further illustrated by and described with reference to wireless communications subsystems, environments, and process flows that relate to transmission of reference signal configuration in broadcast messages for idle and inactive user equipment. Aspects of the disclosure are further illustrated by and described with reference to apparatus diagrams, system diagrams, and flowcharts that relate to transmission of reference signal configuration in broadcast messages for idle and inactive user equipment.

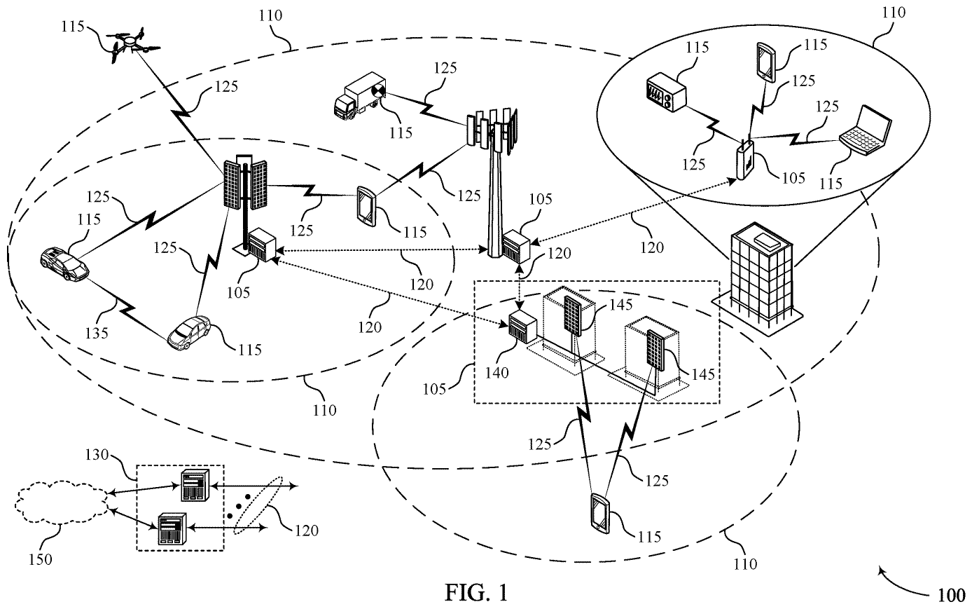

FIG. 1 illustrates an example of a wireless communications system 100 that supports transmission of reference signal configuration in broadcast messages for idle and inactive user equipment in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may receive a broadcast transmission from a base station 105 while the UE 115 is operating in either an idle mode or an inactive mode. In some cases, the broadcast transmission may include a reference signal configuration for communications between the base station 105 and the UE 115. In some cases, the reference signal configuration may indicate one or more reference signal parameters. The UE 115 may receive, while operating in either the idle mode or the inactive mode, one or more reference signals from the base station in accordance with the reference signal configuration. In some cases, the UE 115 may determine one or more channel measurements based at least in part on the one or more reference signals received from the base station.

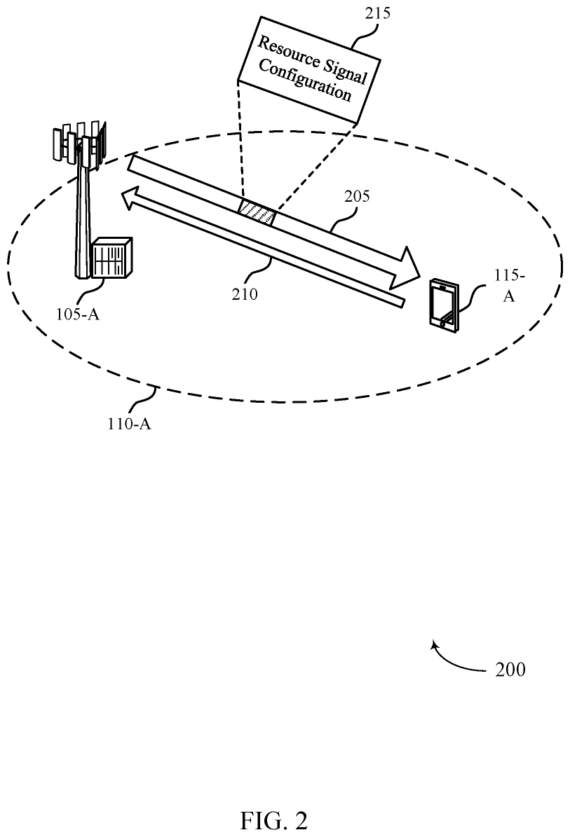

FIG. 2 illustrates an example of a wireless communications subsystem 200 that supports transmission of reference signal configuration in broadcast messages for idle and inactive user equipment in accordance with aspects of the present disclosure. In some examples, wireless communications subsystem 200 may implement aspects of wireless communication system 100.

As illustrated, wireless communications subsystem 200 may include UE 115-a and base station 105-a, which may be examples of a UE 115 or a base station 105, as described herein with reference to FIG. 1. Wireless communications subsystem 200 may also include downlink 205 and uplink 210. Base station 105-a may use downlink 205 to convey control and/or data information to UE 115-a. And UE 115-a may use uplink 210 to convey control and/or data information to base station 105-a. In some cases, downlink 205 may use different time and/or frequency resources than uplink 210.

In some examples, UE 115-a may receive a broadcast transmission from a base station 105-a while the UE 115-a is operating in either an idle mode or an inactive mode. In some cases, the broadcast transmission may include a reference signal configuration 215 for communications between the base station 105-a and the UE 115-a. In some cases, the reference signal configuration 215 may indicate one or more reference signal parameters. The UE 115-a may receive, while operating in either the idle mode or the inactive mode, one or more reference signals from the base station in accordance with the reference signal configuration 215. In some cases, the UE 115-a may determine one or more channel measurements based at least in part on the one or more reference signals received from the base station.

In some cases, the base station 105-a may transmit the resource signal configuration or an indication of the resource signal configuration in a system information block, or a physical downlink control channel, or a physical downlink shared channel, or any combination thereof. In some cases, the base station 105-a may broadcast or group cast a full resource signal configuration, or a partial resource signal configuration, or an indicator of a resource signal configuration, or any combination thereof. The indicator of the resource signal configuration may indicate the resource signal is available or unavailable. In some cases, the indicator of a resource signal configuration may indicate the resource signal configuration is updated or is not updated, or that the resource signal is available and the resource signal configuration is updated or that the resource signal is not available.

The present techniques may improve network efficiency and reduce network latency while UEs (e.g., UE 115-a) conserve power by operating in an inactive or idle mode, thus improving user experience of the one or more UEs based on an improved quality of service. In some cases, the described techniques may support improvements in system efficiency such that UE 115-a may perform channel measurements while in an inactive or idle mode. Additionally, the described techniques may result in improving quality of service by decreasing system latency and improving the reliability of channel measurements, while the UE conserves battery life by continuing to operate in an inactive or idle mode.

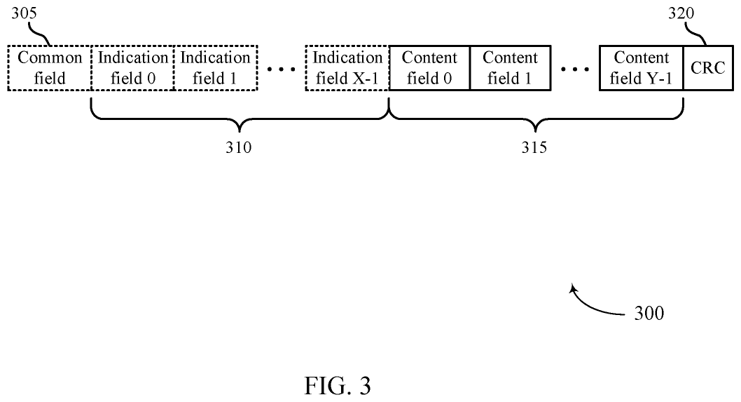

FIG. 3 illustrates an example of an environment 300 that supports transmission of reference signal configuration in broadcast messages for idle and inactive user equipment in accordance with aspects of the present disclosure. In some examples, environment 300 may implement aspects of wireless communication system 100.

In some examples, environment 300 may illustrate an aspect of one or more fields of a physical downlink control channel. In some cases, a base station (e.g., a base station 105) may transmit a resource signal configuration or an indication of a resource signal configuration in one or more fields of a physical downlink control channel (PDCCH) as depicted in environment 300.

In the illustrated example, the one or more fields of the depicted PDCCH may include an optional common field 305, optional dynamic indication field 310, content field 315, and a cyclic redundancy check (CRC) field 320. In some cases, the one or more fields of the depicted PDCCH may include X dynamic indication fields 310 for X groups of UEs and Y content fields 315 for Y groups of UEs. In some cases, X and Y are positive integers and Y is equal to or less than X.

In some cases, the fields of the depicted PDCCH may carry information for multiple groups of UEs associated in the same paging occasion. In some cases, the depicted PDCCH may carry information for a single group of UEs associated in the same paging occasion. In some cases, the dynamic indication field 310 may indicate whether any of the X groups of UEs is paged in a next paging occasion. In some cases, a UE may identify a dynamic indication field 310, where the identified dynamic indication field 310 indicates that a group of UEs of the X group of UEs is paged in a next paging occasion. In some cases, each paged group in the X groups of UEs may be mapped to the Y content fields 315. In some cases, each of the X dynamic indication fields 310 may map to the Y content fields 315 (e.g., mapped one-to-one, dynamic indication field 0 maps to content field 0, dynamic indication field 1 maps to content field 1, etc.).

In some examples, the one or more fields of the depicted PDCCH may not include the common field 305, or may not include the dynamic indication field 310, or may not include either. In some cases, the one or more fields of the depicted PDCCH may include at least the content field 315 and the CRC field 320. In some cases, the content field 315 may carry resource signal configuration information for the Y groups of UEs. In some cases, a first bit of each content field 315 may indicate whether associated UEs are paged (e.g., paged in a next paging occasion). In some cases, the remaining bits of each content field 315 may include the resource signal configuration (e.g., a full resource signal configuration, or a partial resource signal configuration, or an indicator of a resource signal configuration, or any combination thereof). In some cases, a UE may receive the reference signal configuration or an update to the reference signal configuration based on a paging indicator of a content field 315.

In some examples, a UE be in a sleep mode and may wake up (e.g., during a paging occasion) to receive a PDCCH to determine if an update to a resource configuration or a new resource configuration is available. In some cases, the UE may determine based on a PDCCH whether a resource configuration is being broadcast to a group of UEs that includes the UE. In some cases, the UE may periodically wake up and monitor for PDCCH in order to check for the presence of a paging message (e.g., the UE may look for information encrypted by a paging radio network temporary identifier).

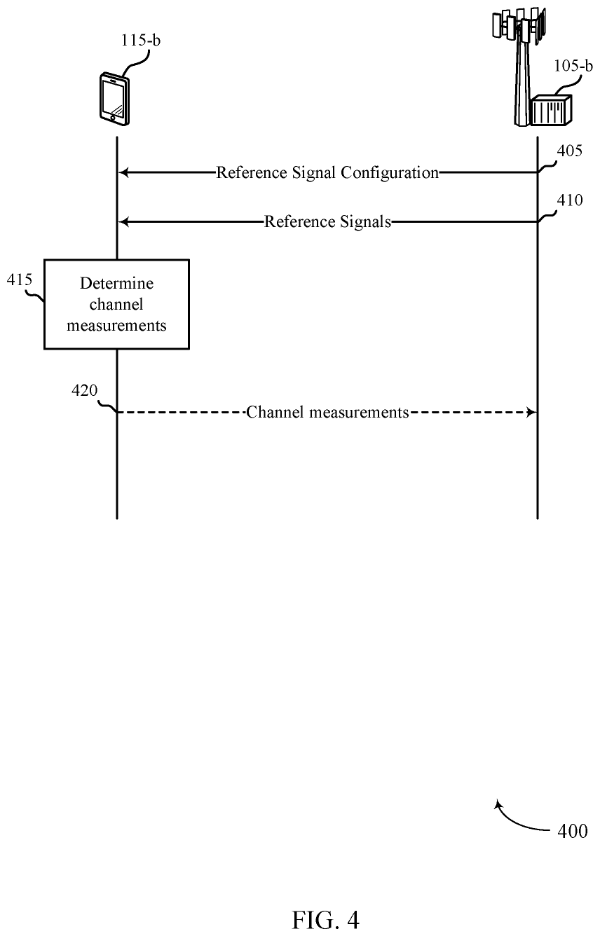

FIG. 4 illustrates an example of a process flow 400 that supports transmission of reference signal configuration in broadcast messages for idle and inactive user equipment in accordance with aspects of the present disclosure. In some examples, process flow 400 may implement aspects of wireless communication system 100. In some examples, process flow 400 may be implemented by or may implement aspects of wireless communications system 100. For instance, UE 115-b and base station 105-b may be examples of corresponding devices described with reference to FIG. 1, among others.

At 405, base station 105-b may transmit a reference signal configuration to UE 115-b. In some cases, the transmitted reference signal configuration may be configured by base station 105-b for communications between the base station 105-b and the UE 115-b. In some cases, base station 105-b may transmit the reference signal configuration in a broadcast transmission or group cast transmission to one or more groups of UEs where one of the groups of UEs includes UE 115-b. In some cases, UE 115-b may be operating in an idle mode or inactive mode when UE 115-b receives the transmitted reference signal configuration. In some cases, the reference signal configuration may indicate one or more reference signal parameters. In some cases, the one or more parameters of the reference signal configuration may include a channel state resource configuration indication (e.g., a zero-power (ZP) channel state information reference signal indicator, a non-zero-power (NZP) channel state information reference signal indicator, CSI-ResourceConfig, ZP-CSI-RS-ResourceSetList, NZP-CSI-RS-ResourceSet, or NZP-CSI-RS-Resource).

In some examples, UE 115-b may receive the reference signal configuration in one or more system information blocks. In some cases, UE 115-b may periodically receive, based at least in part on scheduling information indicated in a type 1 system information block received by the UE 115-b, the one or more system information blocks when a type of the one or more system information blocks does not include the type 1 system information block.

In some examples, UE 115-b may receive an update to the reference signal configuration in one or more system information blocks, where the reference signal configuration or the update to the reference signal configuration, or both, is indicated by one or more bits of a paging downlink control information. In some cases, UE 115-b may determine that the reference signal configuration is updated based at least in part on a system information modification bit of a short message of the paging downlink control information. In some cases, UE 115-b may determine that the reference signal configuration is updated based at least in part on a bit of a set of unused bits of a short message of the paging downlink control information.

In some examples, UE 115-b may receive an indication of the availability of the reference signal or an update to the reference signal configuration in a physical downlink control channel, where the availability or the update is indicated by one or more bits of a paging downlink control information. When the indication indicates the reference signal is available, the base station 105-b may continue to transmit the reference signal. When the indication indicates the reference signal is not available, the base station 105-b may cease or may have ceased to transmit the reference signal (e.g., the indication may indicate that the base station 105-b is not or is no longer transmitting the reference signal). Accordingly, when the indication indicates the reference signal is available, the UE 115-b may determine that base station 105-b continues to transmit the reference signal, thus enabling the UE 115-b to continue to monitor for and to receive the reference signal. When the indication indicates the reference signal is not available, the UE 115-b may determine that base station 105-b is not transmitting the reference signal, in which case the UE 115-b may stop monitoring for the reference signal.

In some cases, UE 115-b may determine that the one or more bits of the paging downlink control information indicate the reference signal is available or the reference signal configuration is updated. In some cases, a set of unused bits of the paging downlink control information, or a set of reserved bits of the paging downlink control information, or both, include the one or more bits of the paging downlink control information. In some cases, the paging downlink control information is associated with physical downlink shared channel scheduling information. In some cases, when the one or more bits of the paging downlink control information indicate that the reference signal is available or that the reference signal configuration is updated, or both, the UE 115-b may receive the reference signal configuration or the updated reference signal configuration (e.g., a set of parameters of the reference signal configuration, or an updated set of parameters of the reference signal configuration) in a system information block or a physical downlink shared channel (e.g., a system information block or physical downlink shared channel scheduled by the paging downlink control information).

In some examples, UE 115-b may determine that the one or more bits of the paging downlink control information includes a first bit to indicate whether the reference signal is available or not available, or a second bit to indicate whether the reference signal configuration is updated or not updated, or both. In some cases, the one or more bits of the paging downlink control information include one bit per reference signal resource of the reference signal configuration. In some cases, the one or more bits of the paging downlink control information include one bit per group of reference signal resources of the reference signal configuration. In some cases, the one or more bits of the paging downlink control information may include one bit per reference signal resource set of the reference signal configuration. In some cases, the one or more bits of the paging downlink control information may include one bit per group of reference signal resource sets of the reference signal configuration.

In some examples, UE 115-b may determine an identifier for each reference signal resource, each reference signal resource set, each group of reference signal resources or each group of reference signal resource sets from a smallest identifier to a largest identifier. In some cases, UE 115-b may map the reference signal resources, reference signal resource sets, groups of reference signal resources or groups of reference signal resource sets to the group of bits in order from the smallest identifier to the largest identifier. In some cases, a reference signal resource, a reference signal resource set, a group of reference signal resources or a group of reference signal resource sets with the smallest identifier is mapped to a least significant bit of the group of bits, a reference signal resource, a reference signal resource set, a group of reference signal resources or a group of reference signal resource sets with the next smallest identifier is mapped to the next least significant bit of the group of bits, and so on until a reference signal resource, a reference signal resource set, a group of reference signal resources or a group of reference signal resource sets with the largest identifier is mapped to a most significant bit of the group of bits.

In some examples, UE 115-b may receive information of the availability of the reference signal configuration or an update to the reference signal configuration in a paging indicator of a physical downlink control channel. In some cases, the physical downlink control channel carries information for at least one group of UE 115-Bs associated with a paging occasion. In some cases, UE 115-b may identify a dynamic indication field of the physical downlink control channel, where the dynamic indication field may indicate that a group of UE 115-Bs of the at least one group of UE 115-Bs is paged in a next paging occasion, the group of UE 115-Bs comprising the UE 115-B. In some cases, UE 115-b may identify a content field of the physical downlink control channel, where a first bit of the content field may indicate whether the UE 115-B is paged in a next paging occasion and remaining bits of the content field includes information of availability or the reference signal or the update to the reference signal configuration.

In some examples, UE 115-b may receive the reference signal configuration or an update to the reference signal configuration in one or more reference signal sequences. In some cases, the reference signal configuration is encoded when at least one reference signal sequence of the one or more reference signal sequences is generated.

In some examples, UE 115-b may receive the reference signal configuration or an update to the reference signal configuration in a physical downlink shared channel. In some cases, UE 115-b may determine one or more bits of a set of unused bits of a short message of a paging downlink control information indicates that the physical downlink shared channel includes the reference signal configuration or the update to the reference signal configuration. In some cases, UE 115-b may determine one or more bits of a set of reserved bits of a paging downlink control information indicates that the physical downlink shared channel includes the reference signal configuration or the update to the reference signal configuration. In some examples, UE 115-b may receive the reference signal configuration or an update to the reference signal configuration in a nonCriticalExtension of a paging message, where pagingRecordList may not be included in the paging message.

In some examples, UE 115-b may receive a second reference signal configuration in a physical downlink shared channel carrying a system information block after receiving the reference signal configuration. In some examples, UE 115-b may receive an update to the reference signal configuration in a physical downlink shared channel scheduled by downlink control information scrambled by a paging radio network temporary identifier. In some examples, UE 115-b may overwrite the reference signal configuration in memory with the second reference signal configuration based at least in part on receiving the second reference signal configuration in the physical downlink shared channel. In some examples, UE 115-b may update at least a portion of the reference signal configuration in memory based at least in part on receiving the update to the reference signal configuration in the physical downlink shared channel.

In some examples, UE 115-b may identify a channel state information resource configuration in the reference signal configuration. In some examples, UE 115-b may identify channel state information resources for resource identifiers linked to a resource set provided in the reference signal configuration, where the channel state information resources may be quasi co-located to one or more synchronization signal blocks.

At 410, base station 105-b may transmit one or more reference signals to UE 115-b. The UE 115-b may receive the one or more reference signals while operating in either the idle mode or the inactive mode. In some cases, UE 115-b may receive the one or more reference signals from base station 105-b in accordance with the reference signal configuration transmitted at 405.

In some examples, UE 115-b may determine an availability of the one or more reference signals based at least in part on the one or more reference signal sequences. In some examples, receiving a first reference signal sequence of the one or more reference signal sequences indicates that the one or more reference signals remain available, receiving a second reference signal sequence of the one or more reference signal sequences and different from the first reference signal sequence indicates that the one or more reference signals do not remain available, and receiving neither the first reference signal sequence nor the second reference signal sequence indicates that the UE 115-B is not being paged in a next paging occasion.

In some examples, the one or more system information blocks include a type 1 system information block when the one or more reference signals at 410 are configured for a serving cell. In some cases, the one or more system information blocks include a type 2 system information block or a type 3 system information block, or both, when the one or more reference signals at 410 are configured for an intra-frequency neighbor cell. In some cases, the one or more system information blocks include a type 4 system information block or a type 5 system information block, or both, when the one or more reference signals 410 are configured for an inter-frequency neighbor cell.

At 415, the UE 115-b may determine one or more channel measurements based at least in part on the one or more reference signals received from the base station 105-b at 410.

At 420, the UE 115-b may optionally transmit one or more channel measurements to base station 105-b. In some cases, UE 115-b may determine one or more channel measurements based at least in part on the one or more reference signals and, in some cases, may transmit one or more of the determined channel measurements to base station 105-b.

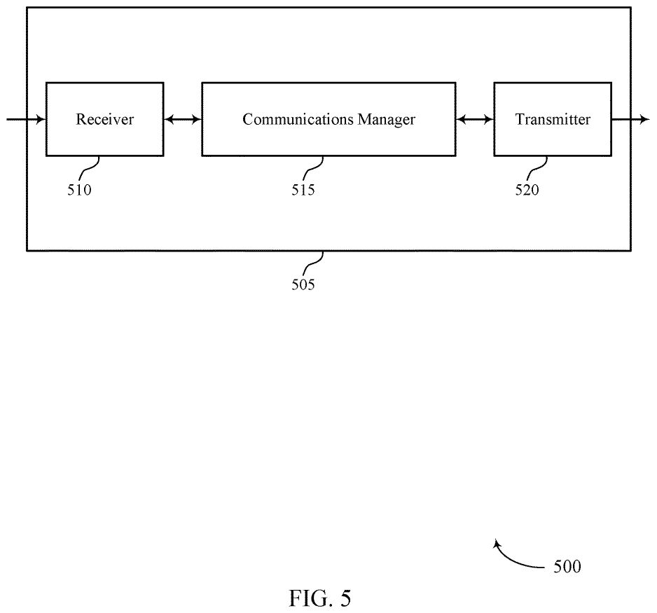

FIG. 5 shows a block diagram 500 of a device 505 that supports transmission of reference signal configuration in broadcast messages for idle and inactive user equipment in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

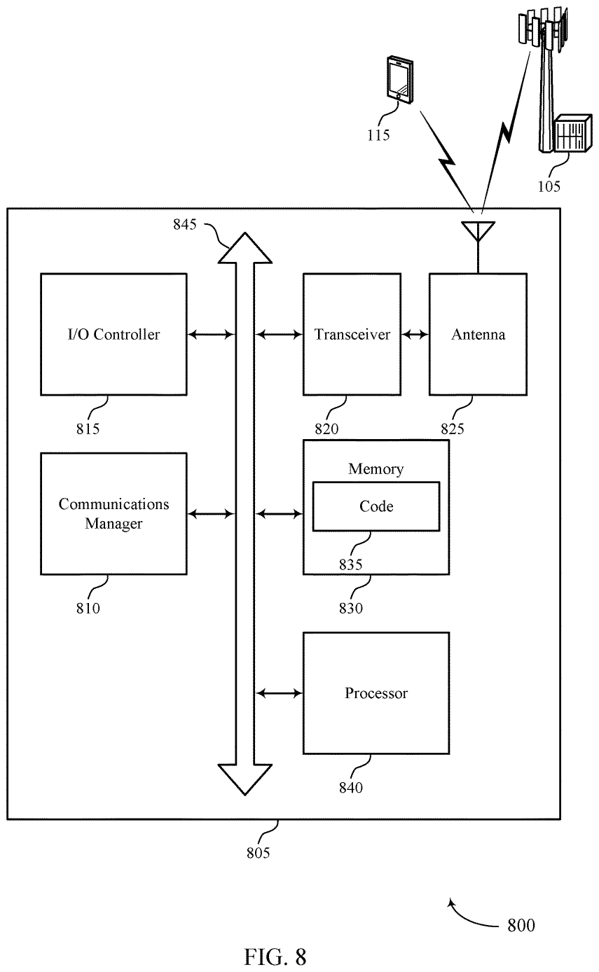

The receiver 510 may receive information such as packets, user data, or control information associated with various information channels (e.g., control channels, data channels, and information related to transmission of reference signal configuration in broadcast messages for idle and inactive user equipment, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receive, while operating in the first mode, one or more reference signals from the base station in accordance with the reference signal configuration, and determine one or more channel measurements based on the one or more reference signals received from the base station. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), an FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

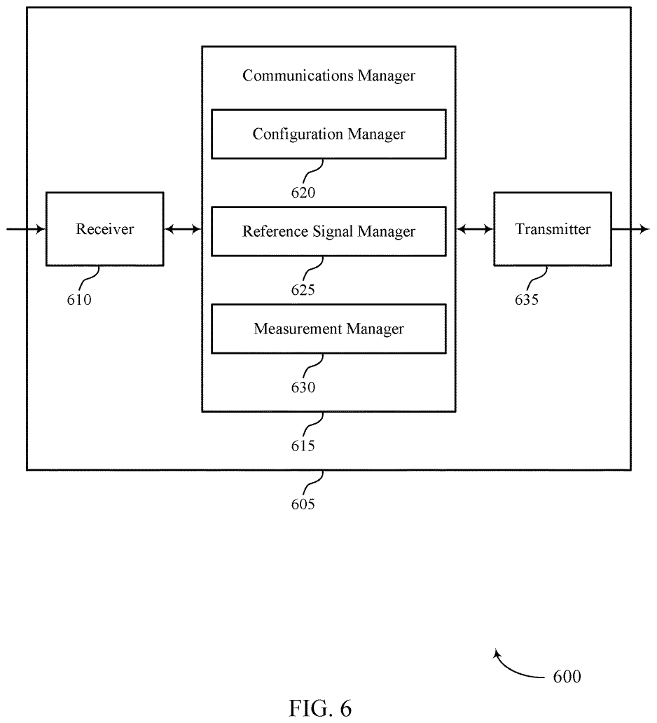

FIG. 6 shows a block diagram 600 of a device 605 that supports transmission of reference signal configuration in broadcast messages for idle and inactive user equipment in accordance with aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to transmission of reference signal configuration in broadcast messages for idle and inactive user equipment, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a configuration manager 620, a reference signal manager 625, and a measurement manager 630. The communications manager 615 may be an example of aspects of the communications manager 810 described herein.

The configuration manager 620 may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode.

The reference signal manager 625 may receive, while operating in the first mode, one or more reference signals from the base station in accordance with the reference signal configuration. The measurement manager 630 may determine one or more channel measurements based on the one or more reference signals received from the base station.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

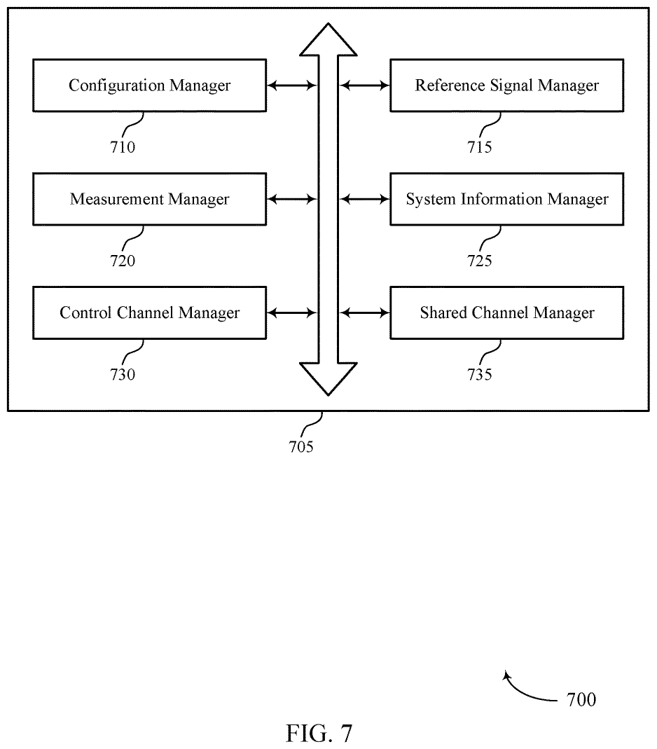

FIG. 7 shows a block diagram 700 of a communications manager 705 that supports transmission of reference signal configuration in broadcast messages for idle and inactive user equipment in accordance with aspects of the present disclosure. The communications manager 705 may be an example of aspects of a communications manager 515, a communications manager 615, or a communications manager 810 described herein. The communications manager 705 may include a configuration manager 710, a reference signal manager 715, a measurement manager 720, a system information manager 725, a control channel manager 730, and a shared channel manager 735. Each of these modules may communicate, directly or indirectly, with one another (e.g., via one or more buses).

The configuration manager 710 may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode.

In some examples, the configuration manager 710 may receive the reference signal configuration or an update to the reference signal configuration in a nonCriticalExtension of a paging message, where pagingRecordList is not included in the paging message. In some examples, the configuration manager 710 may receive a second reference signal configuration in a system information block after receiving the reference signal configuration.

In some examples, the configuration manager 710 may overwrite the reference signal configuration in memory with the second reference signal configuration based on receiving the second reference signal configuration in the system information block. In some examples, the configuration manager 710 may receive an update to the reference signal configuration in a physical downlink shared channel scheduled by downlink control information scrambled by a paging radio network temporary identifier.

In some examples, the configuration manager 710 may update at least a portion of the reference signal configuration in memory based on receiving the update to the reference signal configuration in the physical downlink shared channel. In some examples, the configuration manager 710 may identify a channel state information resource configuration in the reference signal configuration. In some examples, the configuration manager 710 may identify channel state information resources for a resource identifier linked to a resource set provided in the reference signal configuration, where the channel state information resources are mapped to one or more synchronization signal blocks.

The reference signal manager 715 may receive, while operating in the first mode, one or more reference signals from the base station in accordance with the reference signal configuration.

The measurement manager 720 may determine one or more channel measurements based on the one or more reference signals received from the base station.

The system information manager 725 may receive the reference signal configuration in one or more system information blocks.

In some examples, the system information manager 725 may periodically receive, based on scheduling information indicated in a type 1 system information block received by the UE, the one or more system information blocks when a type of the one or more system information blocks does not include the type 1 system information block.

In some examples, the system information manager 725 may receive an update to the reference signal configuration in one or more system information blocks, where the reference signal configuration or the update to the reference signal configuration, or both, is indicated by one or more bits of a paging downlink control information.

In some examples, the system information manager 725 may determine that the reference signal configuration or the update to the reference signal configuration is available based on a system information modification bit of a short message of the paging downlink control information. In some examples, the system information manager 725 may determine that the reference signal configuration or the update to the reference signal configuration is available based on a bit of a set of unused bits of a short message of the paging downlink control information.

In some cases, the one or more system information blocks include a type 1 system information block when the one or more reference signals are configured for a serving cell. In some cases, the one or more system information blocks include a type 2 system information block or a type 3 system information block, or both, when the one or more reference signals are configured for an intra-frequency neighbor cell. In some cases, the one or more system information blocks include a type 4 system information block or a type 5 system information block, or both, when the one or more reference signals are configured for an inter-frequency neighbor cell.

The control channel manager 730 may receive the reference signal configuration or an update to the reference signal configuration in a physical downlink control channel, where the update is indicated by one or more bits of a paging downlink control information.

In some examples, the control channel manager 730 may determine that the one or more bits of the paging downlink control information indicate the reference signal configuration or the update to the reference signal configuration is available in the physical downlink control channel.

In some examples, the control channel manager 730 may determine that the one or more bits of the paging downlink control information includes a first bit to indicate whether the reference signal configuration is in the physical downlink control channel, or a second bit to indicate whether the update to the reference signal configuration is in the physical downlink control channel, or both. In some examples, the control channel manager 730 may determine an identifier for each reference signal resource set of the group of reference signal resource sets from a smallest identifier to a largest identifier.

In some examples, the control channel manager 730 may map the group of reference signal resource sets to the group of bits in order from the smallest identifier to the largest identifier, where a reference signal resource set of the group of reference signal resource sets with the smallest identifier is mapped to a least significant bit of the group of bits and a reference signal resource set of the group of reference signal resource sets with the largest identifier is mapped to a most significant bit of the group of bits.

In some examples, the control channel manager 730 may receive the reference signal configuration or an update to the reference signal configuration in a paging indicator of a physical downlink control channel. In some examples, the control channel manager 730 may identify a dynamic indication field of the physical downlink control channel, where the dynamic indication field indicates that a group of UEs of the at least one group of UEs is paged in a next paging occasion, the group of UEs including the UE.

In some examples, identifying a content field of the physical downlink control channel, where a first bit of the content field indicates whether the UE is paged in a next paging occasion and remaining bits of the content field includes the reference signal configuration or the update to the reference signal configuration.

In some examples, the control channel manager 730 may receive the reference signal configuration or an update to the reference signal configuration in one or more reference signal sequences associated with a physical downlink control channel. In some examples, the control channel manager 730 may determine an availability of the one or more reference signals based on the one or more reference signal sequences associated with the physical downlink control channel.

In some examples, the control channel manager 730 may receive a first reference signal sequence of the one or more reference signal sequences indicates that the one or more reference signals remain available, receiving a second reference signal sequence of the one or more reference signal sequences and different from the first reference signal sequence indicates that the one or more reference signals do not remain available, and receiving neither the first reference signal sequence nor the second reference signal sequence indicates that the UE is not being paged in a next paging occasion.

In some cases, a set of unused bits of the paging downlink control information, or a set of reserved bits of the paging downlink control information, or both, include the one or more bits of the paging downlink control information. In some cases, the paging downlink control information is associated with physical downlink shared channel scheduling information. In some cases, the one or more bits of the paging downlink control information include one bit per reference signal resource of the reference signal configuration. In some cases, the one or more bits of the paging downlink control information include one bit per group of reference signal resources of the reference signal configuration. In some cases, the one or more bits of the paging downlink control information include one or two bits to indicate whether a reference signal resource set of the reference signal configuration is available or unavailable. In some cases, the one or more bits of the paging downlink control information include a group of bits to indicate which reference signal resource sets of a group of reference signal resource sets of the reference signal configuration are available and which reference signal resource sets of the group of reference signal resource sets of the reference signal configuration are unavailable.

In some cases, the physical downlink control channel carries information for at least one group of UEs associated with a paging occasion. In some cases, the reference signal configuration is encoded when at least one reference signal sequence of the one or more reference signal sequences is generated.

The shared channel manager 735 may receive the reference signal configuration or an update to the reference signal configuration in a physical downlink shared channel. In some examples, the shared channel manager 735 may determine one or more bits of a set of unused bits of a short message of a paging downlink control information indicates that the physical downlink shared channel includes the reference signal configuration or the update to the reference signal configuration.

In some examples, the shared channel manager 735 may determine one or more bits of a set of reserved bits of a paging downlink control information indicates that the physical downlink shared channel includes the reference signal configuration or the update to the reference signal configuration.

FIG. 8 shows a diagram of a system 800 including a device 805 that supports transmission of reference signal configuration in broadcast messages for idle and inactive user equipment in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode, receive, while operating in the first mode, one or more reference signals from the base station in accordance with the reference signal configuration, and determine one or more channel measurements based on the one or more reference signals received from the base station.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting transmission of reference signal configuration in broadcast messages for idle and inactive user equipment).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

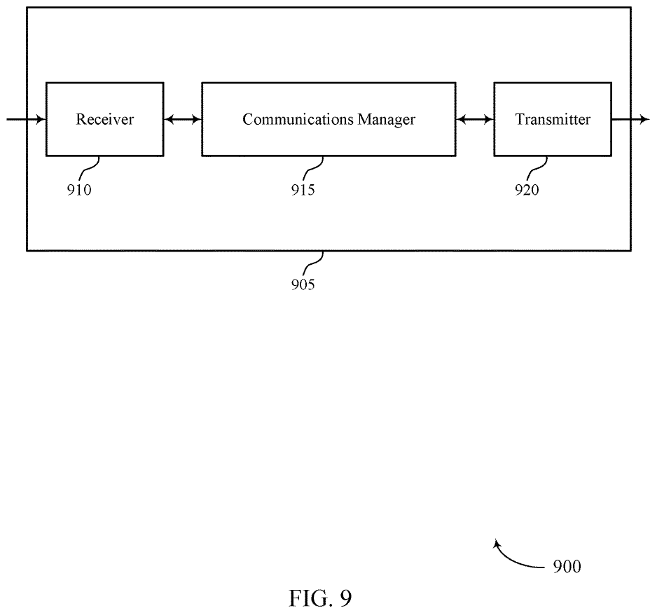

FIG. 9 shows a block diagram 900 of a device 905 that supports transmission of reference signal configuration in broadcast messages for idle and inactive user equipment in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

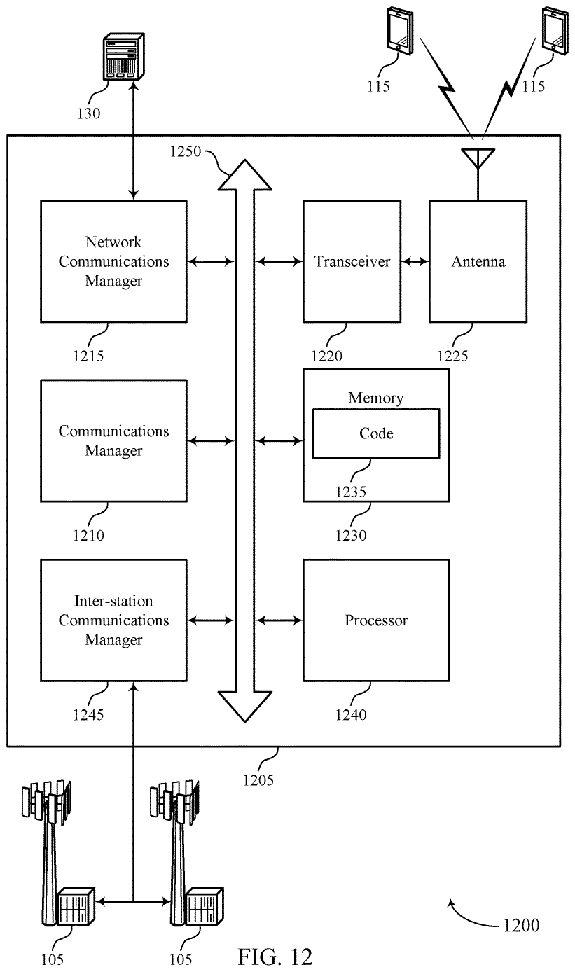

The receiver 910 may receive information such as packets, user data, or control information associated with various information channels (e.g., control channels, data channels, and information related to transmission of reference signal configuration in broadcast messages for idle and inactive user equipment, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may generate a reference signal configuration for communications between the base station and a UE operating in a first mode, the reference signal configuration indicating one or more reference signal parameters and the first mode being either an idle mode or an inactive mode, transmit, to the UE, a broadcast transmission that includes the reference signal configuration, transmit, to the UE while the UE is operating in the first mode, one or more reference signals in accordance with the reference signal configuration, and receive, from the UE, one or more channel measurements based on the one or more reference signals transmitted to the UE. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

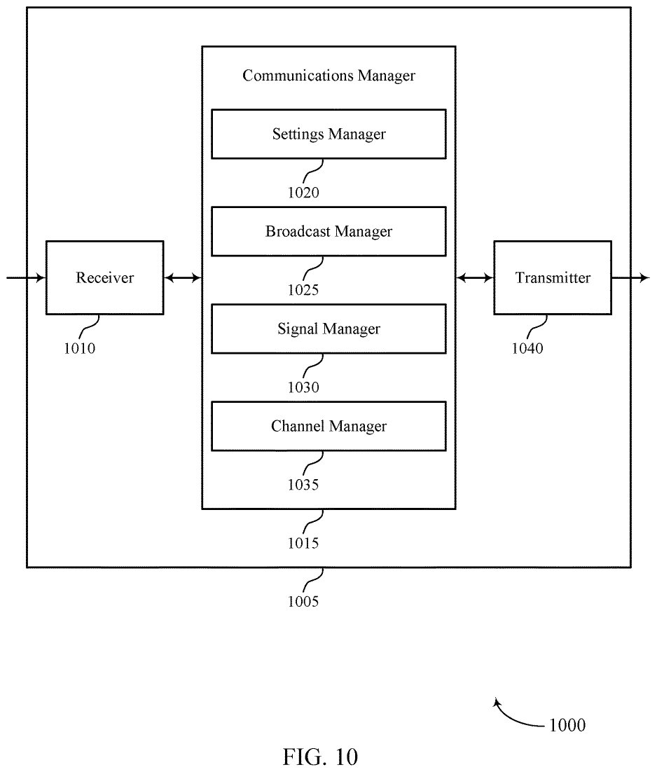

FIG. 10 shows a block diagram 1000 of a device 1005 that supports transmission of reference signal configuration in broadcast messages for idle and inactive user equipment in accordance with aspects of the present disclosure. The device 1005 may be an example of aspects of a device 905, or a base station 105 as described herein. The device 1005 may include a receiver 1010, a communications manager 1015, and a transmitter 1040. The device 1005 may also include a processor. Each of these components may be in communication with one another (e.g., via one or more buses).

The receiver 1010 may receive information such as packets, user data, or control information associated with various information channels (e.g., control channels, data channels, and information related to transmission of reference signal configuration in broadcast messages for idle and inactive user equipment, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a settings manager 1020, a broadcast manager 1025, a signal manager 1030, and a channel manager 1035. The communications manager 1015 may be an example of aspects of the communications manager 1210 described herein.

The settings manager 1020 may generate a reference signal configuration for communications between the base station and a UE operating in a first mode, the reference signal configuration indicating one or more reference signal parameters and the first mode being either an idle mode or an inactive mode. The broadcast manager 1025 may transmit, to the UE, a broadcast transmission that includes the reference signal configuration.

The signal manager 1030 may transmit, to the UE while the UE is operating in the first mode, one or more reference signals in accordance with the reference signal configuration. The channel manager 1035 may receive, from the UE, one or more channel measurements based on the one or more reference signals transmitted to the UE.

The transmitter 1040 may transmit signals generated by other components of the device 1005. In some examples, the transmitter 1040 may be collocated with a receiver 1010 in a transceiver module. For example, the transmitter 1040 may be an example of aspects of the transceiver 1220 described with reference to FIG. 12. The transmitter 1040 may utilize a single antenna or a set of antennas.

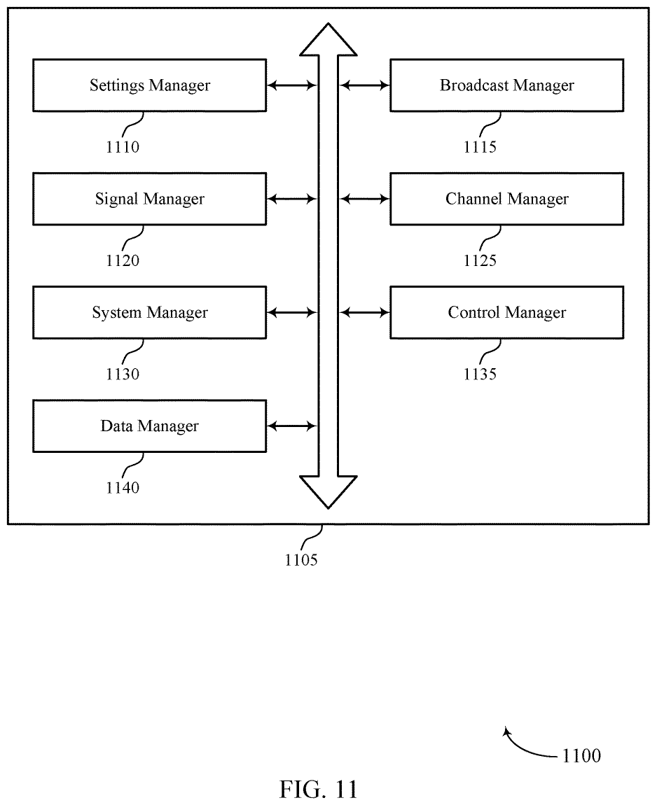

FIG. 11 shows a block diagram 1100 of a communications manager 1105 that supports transmission of reference signal configuration in broadcast messages for idle and inactive user equipment in accordance with aspects of the present disclosure. The communications manager 1105 may be an example of aspects of a communications manager 915, a communications manager 1015, or a communications manager 1210 described herein. The communications manager 1105 may include a settings manager 1110, a broadcast manager 1115, a signal manager 1120, a channel manager 1125, a system manager 1130, a control manager 1135, and a data manager 1140. Each of these modules may communicate, directly or indirectly, with one another (e.g., via one or more buses).

The settings manager 1110 may generate a reference signal configuration for communications between the base station and a UE operating in a first mode, the reference signal configuration indicating one or more reference signal parameters and the first mode being either an idle mode or an inactive mode.

In some examples, the settings manager 1110 may transmit the reference signal configuration or an update to the reference signal configuration in a nonCriticalExtension of a paging message, where pagingRecordList is not included in the paging message.

In some examples, the settings manager 1110 may transmit a second reference signal configuration in a system information block after transmitting the reference signal configuration, where the UE is configured to overwrite the reference signal configuration in memory with the second reference signal configuration based on the UE receiving the second reference signal configuration in the system information block.

In some examples, the settings manager 1110 may configure the reference signal configuration to include a channel state information resource configuration.

In some examples, the settings manager 1110 may configure the reference signal configuration to include channel state information resources for a resource identifier linked to a resource set, where the channel state information resources are mapped to one or more synchronization signal blocks.

The broadcast manager 1115 may transmit, to the UE, a broadcast transmission that includes the reference signal configuration. The signal manager 1120 may transmit, to the UE while the UE is operating in the first mode, one or more reference signals in accordance with the reference signal configuration.

The channel manager 1125 may receive, from the UE, one or more channel measurements based on the one or more reference signals transmitted to the UE. The system manager 1130 may transmit the reference signal configuration in one or more system information blocks.

In some examples, the system manager 1130 may periodically transmit, based on scheduling information indicated in a type 1 system information block transmitted to the UE by the base station, the one or more system information blocks when a type of the one or more system information blocks does not include the type 1 system information block.

In some examples, the system manager 1130 may transmit an update to the reference signal configuration in one or more system information blocks, where the reference signal configuration or the update to the reference signal configuration, or both, is indicated by one or more bits of a paging downlink control information.

In some examples, the system manager 1130 may indicate that the reference signal configuration or the update to the reference signal configuration is available based on a system information modification bit of a short message of the paging downlink control information.

In some examples, the system manager 1130 may indicate that the reference signal configuration or the update to the reference signal configuration is available based on a bit of a set of unused bits of a short message of the paging downlink control information.

In some cases, the one or more system information blocks include a type 1 system information block when the one or more reference signals are configured for a serving cell. In some cases, the one or more system information blocks include a type 2 system information block or a type 3 system information block, or both, when the one or more reference signals are configured for an intra-frequency neighbor cell. In some cases, the one or more system information blocks include a type 4 system information block or a type 5 system information block, or both, when the one or more reference signals are configured for an inter-frequency neighbor cell.

The control manager 1135 may transmit the reference signal configuration or an update to the reference signal configuration in a physical downlink control channel, where the update is indicated by one or more bits of a paging downlink control information. In some examples, the control manager 1135 may indicate in the one or more bits of the paging downlink control information that the reference signal configuration or the update to the reference signal configuration is available in the physical downlink control channel.

In some examples, the control manager 1135 may configure a first bit of the one or more bits of the paging downlink control information to indicate whether the reference signal configuration is in the physical downlink control channel, or a second bit of the one or more bits of the paging downlink control information to indicate whether the update to the reference signal configuration is in the physical downlink control channel, or configuring both. In some examples, the control manager 1135 may configure the one or more bits of the paging downlink control information to include one bit per reference signal resource of the reference signal configuration.

In some examples, the control manager 1135 may configure the one or more bits of the paging downlink control information to include one bit per group of reference signal resources of the reference signal configuration. In some examples, the control manager 1135 may configure the one or more bits of the paging downlink control information to include one or two bits to indicate whether a reference signal resource set of the reference signal configuration is available or unavailable.

In some examples, the control manager 1135 may configure the one or more bits of the paging downlink control information to include a group of bits to indicate which reference signal resource sets of a group of reference signal resource sets of the reference signal configuration are available and which reference signal resource sets of the group of reference signal resource sets of the reference signal configuration are unavailable.

In some examples, the control manager 1135 may determine an identifier for each reference signal resource set of the group of reference signal resource sets from a smallest identifier to a largest identifier. In some examples, the control manager 1135 may map the group of reference signal resource sets to the group of bits in order from the smallest identifier to the largest identifier, where a reference signal resource set of the group of reference signal resource sets with the smallest identifier is mapped to a least significant bit of the group of bits and a reference signal resource set of the group of reference signal resource sets with the largest identifier is mapped to a most significant bit of the group of bits.

In some examples, the control manager 1135 may transmit the reference signal configuration or an update to the reference signal configuration in a paging indicator of a physical downlink control channel. In some examples, the control manager 1135 may identify a dynamic indication field of the physical downlink control channel, where the dynamic indication field indicates that a group of UEs of the at least one group of UEs is paged in a next paging occasion, the group of UEs including the UE.

In some examples, the control manager 1135 may configure a first bit of a content field of the physical downlink control channel to indicate whether the UE is paged in a next paging occasion and remaining bits of the content field to include the reference signal configuration or the update to the reference signal configuration. In some examples, the control manager 1135 may transmit the reference signal configuration or an update to the reference signal configuration in one or more reference signal sequences associated with a physical downlink control channel.

In some examples, the control manager 1135 may encode the reference signal configuration when at least one reference signal sequence of the one or more reference signal sequences is generated. In some examples, the control manager 1135 may indicate an availability of the one or more reference signals based on the one or more reference signal sequences associated with the physical downlink control channel.

In some examples, the control manager 1135 may transmit a first reference signal sequence of the one or more reference signal sequences indicates that the one or more reference signals remain available, transmitting a second reference signal sequence of the one or more reference signal sequences and different from the first reference signal sequence indicates that the one or more reference signals do not remain available, and transmitting neither the first reference signal sequence nor the second reference signal sequence indicates that the UE is not being paged in a next paging occasion.

In some cases, a set of unused bits of the paging downlink control information, or a set of reserved bits of the paging downlink control information, or both, include the one or more bits of the paging downlink control information. In some cases, the paging downlink control information is associated with physical downlink shared channel scheduling information. In some cases, the physical downlink control channel carries information for at least one group of UEs associated with a paging occasion.

The data manager 1140 may transmit the reference signal configuration or an update to the reference signal configuration in a physical downlink shared channel. In some examples, the data manager 1140 may configure one or more bits of a set of unused bits of a short message of a paging downlink control information to indicate that the physical downlink shared channel includes the reference signal configuration or the update to the reference signal configuration.

In some examples, the data manager 1140 may configure one or more bits of a set of reserved bits of a paging downlink control information to indicate that the physical downlink shared channel includes the reference signal configuration or the update to the reference signal configuration. In some examples, the data manager 1140 may transmit an update to the reference signal configuration in a physical downlink shared channel scheduled by downlink control information scrambled by a paging radio network temporary identifier, where the UE is configured to update at least a portion of the reference signal configuration in memory based on the UE receiving the update to the reference signal configuration in the physical downlink shared channel.

FIG. 12 shows a diagram of a system 1200 including a device 1205 that supports transmission of reference signal configuration in broadcast messages for idle and inactive user equipment in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may generate a reference signal configuration for communications between the base station and a UE operating in a first mode, the reference signal configuration indicating one or more reference signal parameters and the first mode being either an idle mode or an inactive mode, transmit, to the UE, a broadcast transmission that includes the reference signal configuration, transmit, to the UE while the UE is operating in the first mode, one or more reference signals in accordance with the reference signal configuration, and receive, from the UE, one or more channel measurements based on the one or more reference signals transmitted to the UE.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described herein. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting transmission of reference signal configuration in broadcast messages for idle and inactive user equipment).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

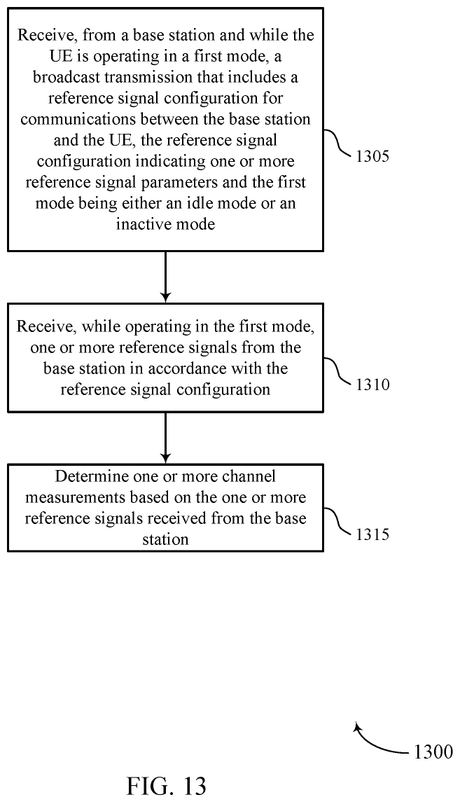

FIG. 13 shows a flowchart illustrating a method 1300 that supports transmission of reference signal configuration in broadcast messages for idle and inactive user equipment in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1305, the UE may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode. The operations of 1305 may be performed according to the methods described herein. In some examples, aspects of the operations of 1305 may be performed by a configuration manager as described with reference to FIGS. 5 through 8.

At 1310, the UE may receive, while operating in the first mode, one or more reference signals from the base station in accordance with the reference signal configuration. The operations of 1310 may be performed according to the methods described herein. In some examples, aspects of the operations of 1310 may be performed by a reference signal manager as described with reference to FIGS. 5 through 8.

At 1315, the UE may determine one or more channel measurements based on the one or more reference signals received from the base station. The operations of 1315 may be performed according to the methods described herein. In some examples, aspects of the operations of 1315 may be performed by a measurement manager as described with reference to FIGS. 5 through 8.

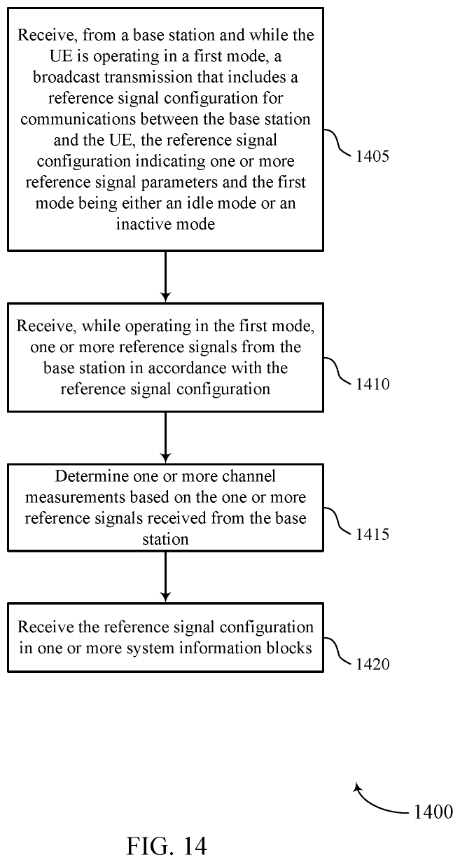

FIG. 14 shows a flowchart illustrating a method 1400 that supports transmission of reference signal configuration in broadcast messages for idle and inactive user equipment in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1405, the UE may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode. The operations of 1405 may be performed according to the methods described herein. In some examples, aspects of the operations of 1405 may be performed by a configuration manager as described with reference to FIGS. 5 through 8.

At 1410, the UE may receive, while operating in the first mode, one or more reference signals from the base station in accordance with the reference signal configuration. The operations of 1410 may be performed according to the methods described herein. In some examples, aspects of the operations of 1410 may be performed by a reference signal manager as described with reference to FIGS. 5 through 8.

At 1415, the UE may determine one or more channel measurements based on the one or more reference signals received from the base station. The operations of 1415 may be performed according to the methods described herein. In some examples, aspects of the operations of 1415 may be performed by a measurement manager as described with reference to FIGS. 5 through 8.

At 1420, the UE may receive the reference signal configuration in one or more system information blocks. The operations of 1420 may be performed according to the methods described herein. In some examples, aspects of the operations of 1420 may be performed by a system information manager as described with reference to FIGS. 5 through 8.

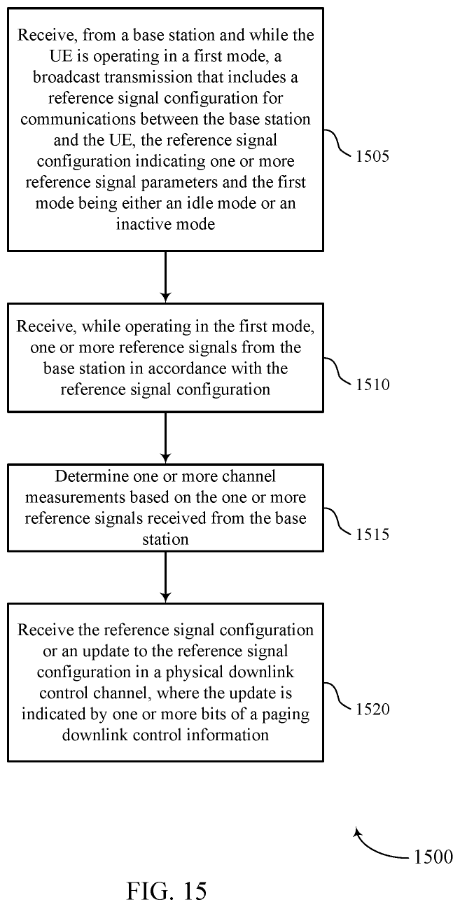

FIG. 15 shows a flowchart illustrating a method 1500 that supports transmission of reference signal configuration in broadcast messages for idle and inactive user equipment in accordance with aspects of the present disclosure. The operations of method 1500 may be implemented by a UE 115 or its components as described herein. For example, the operations of method 1500 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1505, the UE may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode. The operations of 1505 may be performed according to the methods described herein. In some examples, aspects of the operations of 1505 may be performed by a configuration manager as described with reference to FIGS. 5 through 8.

At 1510, the UE may receive, while operating in the first mode, one or more reference signals from the base station in accordance with the reference signal configuration. The operations of 1510 may be performed according to the methods described herein. In some examples, aspects of the operations of 1510 may be performed by a reference signal manager as described with reference to FIGS. 5 through 8.

At 1515, the UE may determine one or more channel measurements based on the one or more reference signals received from the base station. The operations of 1515 may be performed according to the methods described herein. In some examples, aspects of the operations of 1515 may be performed by a measurement manager as described with reference to FIGS. 5 through 8.

At 1520, the UE may receive the reference signal configuration or an update to the reference signal configuration in a physical downlink control channel, where the update is indicated by one or more bits of a paging downlink control information. The operations of 1520 may be performed according to the methods described herein. In some examples, aspects of the operations of 1520 may be performed by a control channel manager as described with reference to FIGS. 5 through 8.

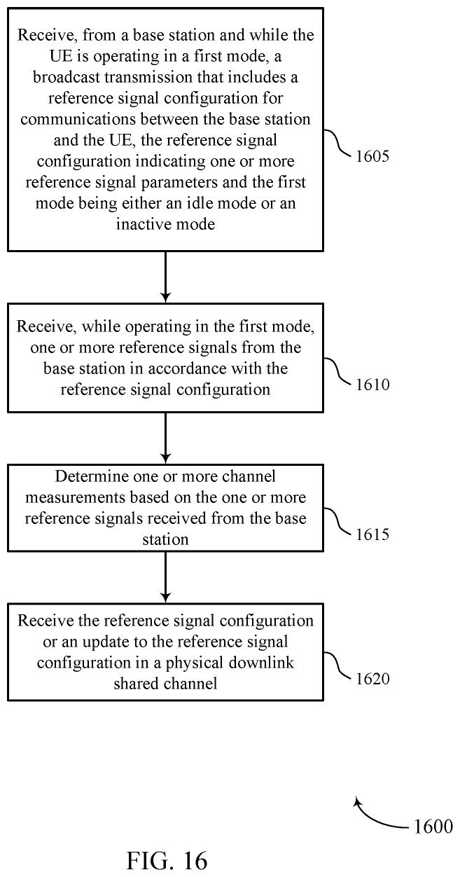

FIG. 16 shows a flowchart illustrating a method 1600 that supports transmission of reference signal configuration in broadcast messages for idle and inactive user equipment in accordance with aspects of the present disclosure. The operations of method 1600 may be implemented by a UE 115 or its components as described herein. For example, the operations of method 1600 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1605, the UE may receive, from a base station and while the UE is operating in a first mode, a broadcast transmission that includes a reference signal configuration for communications between the base station and the UE, the reference signal configuration indicating one or more reference signal parameters and the first mode being either an idle mode or an inactive mode. The operations of 1605 may be performed according to the methods described herein. In some examples, aspects of the operations of 1605 may be performed by a configuration manager as described with reference to FIGS. 5 through 8.

At 1610, the UE may receive, while operating in the first mode, one or more reference signals from the base station in accordance with the reference signal configuration. The operations of 1610 may be performed according to the methods described herein. In some examples, aspects of the operations of 1610 may be performed by a reference signal manager as described with reference to FIGS. 5 through 8.

At 1615, the UE may determine one or more channel measurements based on the one or more reference signals received from the base station. The operations of 1615 may be performed according to the methods described herein. In some examples, aspects of the operations of 1615 may be performed by a measurement manager as described with reference to FIGS. 5 through 8.

At 1620, the UE may receive the reference signal configuration or an update to the reference signal configuration in a physical downlink shared channel. The operations of 1620 may be performed according to the methods described herein. In some examples, aspects of the operations of 1620 may be performed by a shared channel manager as described with reference to FIGS. 5 through 8.

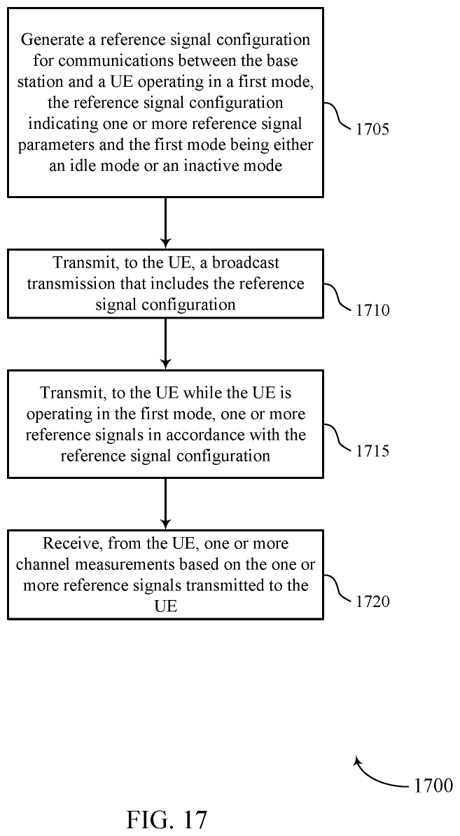

FIG. 17 shows a flowchart illustrating a method 1700 that supports transmission of reference signal configuration in broadcast messages for idle and inactive user equipment in accordance with aspects of the present disclosure. The operations of method 1700 may be implemented by a base station 105 or its components as described herein. For example, the operations of method 1700 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 1705, the base station may generate a reference signal configuration for communications between the base station and a UE operating in a first mode, the reference signal configuration indicating one or more reference signal parameters and the first mode being either an idle mode or an inactive mode. The operations of 1705 may be performed according to the methods described herein. In some examples, aspects of the operations of 1705 may be performed by a settings manager as described with reference to FIGS. 9 through 12.

At 1710, the base station may transmit, to the UE, a broadcast transmission that includes the reference signal configuration. The operations of 1710 may be performed according to the methods described herein. In some examples, aspects of the operations of 1710 may be performed by a broadcast manager as described with reference to FIGS. 9 through 12.

At 1715, the base station may transmit, to the UE while the UE is operating in the first mode, one or more reference signals in accordance with the reference signal configuration. The operations of 1715 may be performed according to the methods described herein. In some examples, aspects of the operations of 1715 may be performed by a signal manager as described with reference to FIGS. 9 through 12.

At 1720, the base station may receive, from the UE, one or more channel measurements based on the one or more reference signals transmitted to the UE. The operations of 1720 may be performed according to the methods described herein. In some examples, aspects of the operations of 1720 may be performed by a channel manager as described with reference to FIGS. 9 through 12.

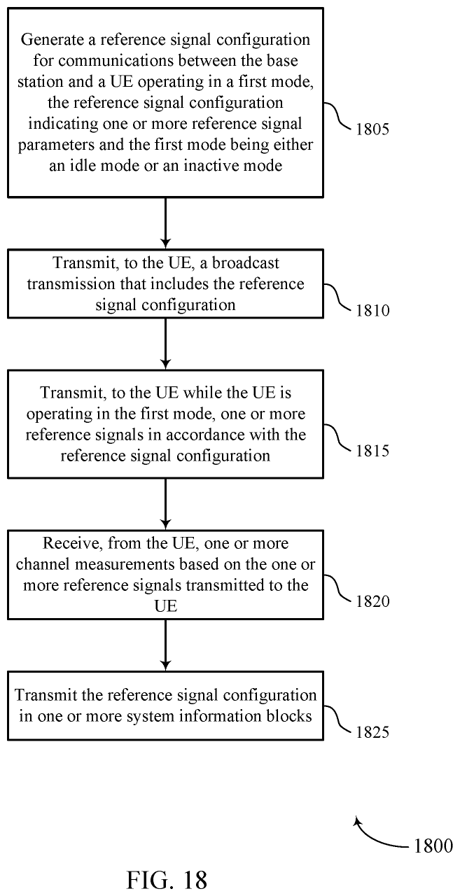

FIG. 18 shows a flowchart illustrating a method 1800 that supports transmission of reference signal configuration in broadcast messages for idle and inactive user equipment in accordance with aspects of the present disclosure. The operations of method 1800 may be implemented by a base station 105 or its components as described herein. For example, the operations of method 1800 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 1805, the base station may generate a reference signal configuration for communications between the base station and a UE operating in a first mode, the reference signal configuration indicating one or more reference signal parameters and the first mode being either an idle mode or an inactive mode. The operations of 1805 may be performed according to the methods described herein. In some examples, aspects of the operations of 1805 may be performed by a settings manager as described with reference to FIGS. 9 through 12.

At 1810, the base station may transmit, to the UE, a broadcast transmission that includes the reference signal configuration. The operations of 1810 may be performed according to the methods described herein. In some examples, aspects of the operations of 1810 may be performed by a broadcast manager as described with reference to FIGS. 9 through 12.

At 1815, the base station may transmit, to the UE while the UE is operating in the first mode, one or more reference signals in accordance with the reference signal configuration. The operations of 1815 may be performed according to the methods described herein. In some examples, aspects of the operations of 1815 may be performed by a signal manager as described with reference to FIGS. 9 through 12.

At 1820, the base station may receive, from the UE, one or more channel measurements based on the one or more reference signals transmitted to the UE. The operations of 1820 may be performed according to the methods described herein. In some examples, aspects of the operations of 1820 may be performed by a channel manager as described with reference to FIGS. 9 through 12.

At 1825, the base station may transmit the reference signal configuration in one or more system information blocks. The operations of 1825 may be performed according to the methods described herein. In some examples, aspects of the operations of 1825 may be performed by a system manager as described with reference to FIGS. 9 through 12.

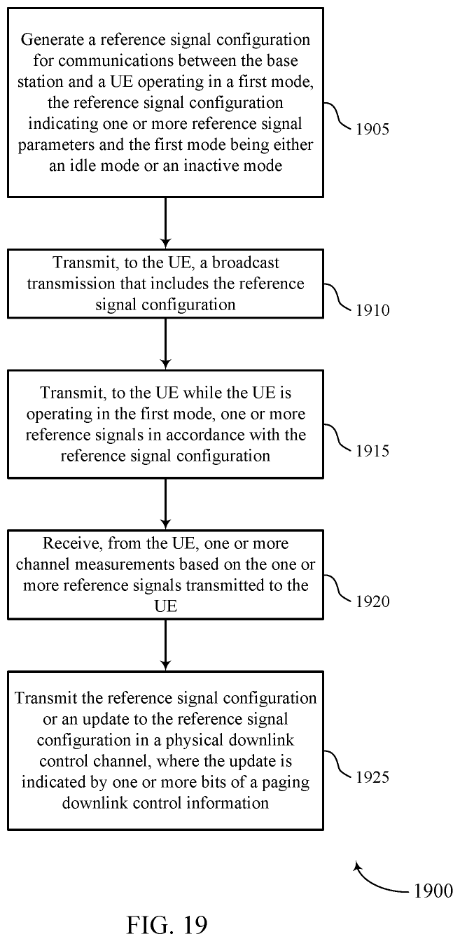

FIG. 19 shows a flowchart illustrating a method 1900 that supports transmission of reference signal configuration in broadcast messages for idle and inactive user equipment in accordance with aspects of the present disclosure. The operations of method 1900 may be implemented by a base station 105 or its components as described herein. For example, the operations of method 1900 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 1905, the base station may generate a reference signal configuration for communications between the base station and a UE operating in a first mode, the reference signal configuration indicating one or more reference signal parameters and the first mode being either an idle mode or an inactive mode. The operations of 1905 may be performed according to the methods described herein. In some examples, aspects of the operations of 1905 may be performed by a settings manager as described with reference to FIGS. 9 through 12.

At 1910, the base station may transmit, to the UE, a broadcast transmission that includes the reference signal configuration. The operations of 1910 may be performed according to the methods described herein. In some examples, aspects of the operations of 1910 may be performed by a broadcast manager as described with reference to FIGS. 9 through 12.

At 1915, the base station may transmit, to the UE while the UE is operating in the first mode, one or more reference signals in accordance with the reference signal configuration. The operations of 1915 may be performed according to the methods described herein. In some examples, aspects of the operations of 1915 may be performed by a signal manager as described with reference to FIGS. 9 through 12.

At 1920, the base station may receive, from the UE, one or more channel measurements based on the one or more reference signals transmitted to the UE. The operations of 1920 may be performed according to the methods described herein. In some examples, aspects of the operations of 1920 may be performed by a channel manager as described with reference to FIGS. 9 through 12.

At 1925, the base station may transmit the reference signal configuration or an update to the reference signal configuration in a physical downlink control channel, where the update is indicated by one or more bits of a paging downlink control information. The operations of 1925 may be performed according to the methods described herein. In some examples, aspects of the operations of 1925 may be performed by a control manager as described with reference to FIGS. 9 through 12.

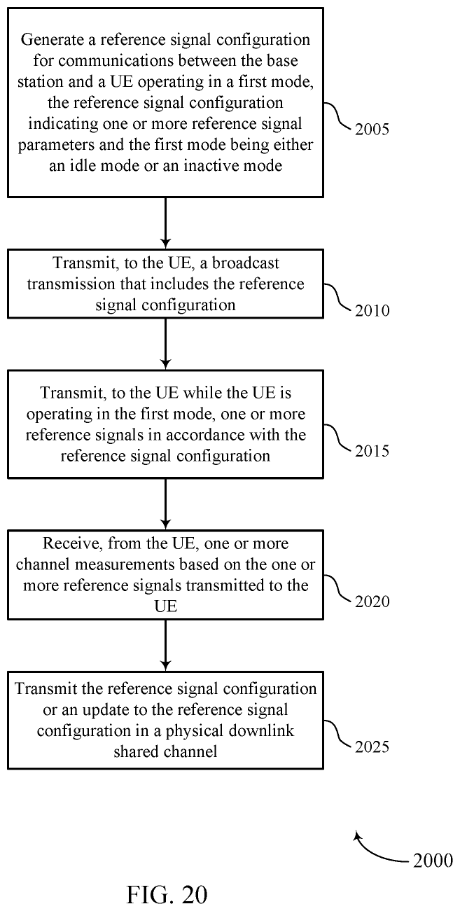

FIG. 20 shows a flowchart illustrating a method 2000 that supports transmission of reference signal configuration in broadcast messages for idle and inactive user equipment in accordance with aspects of the present disclosure. The operations of method 2000 may be implemented by a base station 105 or its components as described herein. For example, the operations of method 2000 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 2005, the base station may generate a reference signal configuration for communications between the base station and a UE operating in a first mode, the reference signal configuration indicating one or more reference signal parameters and the first mode being either an idle mode or an inactive mode. The operations of 2005 may be performed according to the methods described herein. In some examples, aspects of the operations of 2005 may be performed by a settings manager as described with reference to FIGS. 9 through 12.

At 2010, the base station may transmit, to the UE, a broadcast transmission that includes the reference signal configuration. The operations of 2010 may be performed according to the methods described herein. In some examples, aspects of the operations of 2010 may be performed by a broadcast manager as described with reference to FIGS. 9 through 12.

At 2015, the base station may transmit, to the UE while the UE is operating in the first mode, one or more reference signals in accordance with the reference signal configuration. The operations of 2015 may be performed according to the methods described herein. In some examples, aspects of the operations of 2015 may be performed by a signal manager as described with reference to FIGS. 9 through 12.

At 2020, the base station may receive, from the UE, one or more channel measurements based on the one or more reference signals transmitted to the UE. The operations of 2020 may be performed according to the methods described herein. In some examples, aspects of the operations of 2020 may be performed by a channel manager as described with reference to FIGS. 9 through 12.

At 2025, the base station may transmit the reference signal configuration or an update to the reference signal configuration in a physical downlink shared channel. The operations of 2025 may be performed according to the methods described herein. In some examples, aspects of the operations of 2025 may be performed by a data manager as described with reference to FIGS. 9 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications at a user equipment (UE), comprising:
one or more processors;
one or more memories coupled with the one or more processors; and
instructions stored in the one or more memories and executable by the one or more processors to cause the apparatus to:
receive, from a base station, a broadcast transmission comprising a reference signal configuration for communications between the base station and the UE while the UE is operating in a first mode, the reference signal configuration indicating one or more reference signal parameters and the first mode being either an idle mode or an inactive mode;
receive one or more reference signals from the base station in accordance with the reference signal configuration while operating in the first mode;
determine one or more channel measurements based at least in part on the one or more reference signals received from the base station;
receive, in a paging indicator of a physical downlink control channel (PDCCH), an indication of an availability of a reference signal of the one or more reference signals or an indication of an update to the reference signal configuration, wherein the PDCCH carries information for a group of at least one UE associated with a paging occasion; and
identify a content field of the PDCCH, wherein a first bit of the content field indicates whether the UE is paged in a next paging occasion, and a second bit of the content field comprises the indication of the availability of the reference signal or the indication of the update to the reference signal configuration.

2. The apparatus of claim 1, wherein one or more bits of paging downlink control information comprise the indication of the availability of the reference signal or the indication of the update to the reference signal configuration.

3. The apparatus of claim 2, wherein the instructions are further executable by the one or more processors to cause the apparatus to:
determine that the one or more bits of the paging downlink control information indicate that the reference signal is available for the UE or that there is an update to the reference signal configuration.

4. The apparatus of claim 2, wherein a set of unused bits of the paging downlink control information, or a set of reserved bits of the paging downlink control information, or both, comprise the one or more bits of the paging downlink control information.

5. The apparatus of claim 2, wherein the paging downlink control information is associated with physical downlink shared channel scheduling information.

6. The apparatus of claim 2, wherein the one or more bits of the paging downlink control information comprise an indication of each reference signal resource of the reference signal configuration.

7. The apparatus of claim 2, wherein the one or more bits of the paging downlink control information comprise an indication of each reference signal resource group of the reference signal configuration.

8. The apparatus of claim 2, wherein the one or more bits of the paging downlink control information comprise an indication of each reference signal resource set of the reference signal configuration.

9. The apparatus of claim 1, wherein the instructions are further executable by the one or more processors to cause the apparatus to:
identify a dynamic indication field of the physical downlink control channel, wherein the dynamic indication field indicates that a group of UEs in the group of the at least one UE is paged in a next paging occasion, the group of UEs comprising the UE.

10. An apparatus for wireless communications at a base station, comprising:
one or more processors;
one or more memories coupled with the one or more processors; and
instructions stored in the one or more memories and executable by the one or more processors to cause the apparatus to:
generate a reference signal configuration for communications between the base station and a UE operating in a first mode, the reference signal configuration indicating one or more reference signal parameters and the first mode being either an idle mode or an inactive mode;
transmit, to the UE, a broadcast transmission comprising the reference signal configuration;
transmit one or more reference signals to the UE in accordance with the reference signal configuration when the UE is operating in the first mode;
receive, from the UE, one or more channel measurements based at least in part on the one or more reference signals transmitted to the UE;
transmit, in a paging indicator of a physical downlink control channel, an indication of an availability of a reference signal of the one or more reference signals or an indication of an update to the reference signal configuration, wherein the physical downlink control channel carries information for a group of at least one UE associated with a paging occasion; and
configure a first bit of a content field of the physical downlink control channel to indicate whether the UE is paged in a next paging occasion, and configuring remaining bits of the content field to include the indication of the availability of the reference signal or the indication of the update of the reference signal configuration.

11. The apparatus of claim 10, wherein one or more bits of paging downlink control information comprise the indication of the availability of the reference signal or the indication of the update to the reference signal configuration.

12. The apparatus of claim 11, wherein the instructions are further executable by the one or more processors to cause the apparatus to:
indicate, in the one or more bits of the paging downlink control information, that the reference signal is available for the UE or that there is an update to the reference signal configuration.

13. The apparatus of claim 11, wherein a set of unused bits of the paging downlink control information, or a set of reserved bits of the paging downlink control information, or both, comprise the one or more bits of the paging downlink control information.

14. The apparatus of claim 11, wherein the paging downlink control information is associated with physical downlink shared channel scheduling information.

15. The apparatus of claim 11, wherein the instructions are further executable by the one or more processors to cause the apparatus to:
configure the one or more bits of the paging downlink control information to include an indication of each reference signal resource of the reference signal configuration.

16. The apparatus of claim 11, wherein the instructions are further executable by the one or more processors to cause the apparatus to:
configure the one or more bits of the paging downlink control information to include an indication of each reference signal resource group of the reference signal configuration.

17. The apparatus of claim 11, wherein the instructions are further executable by the one or more processors to cause the apparatus to:
configure the one or more bits of the paging downlink control information to include an indication of each reference signal resource set of the reference signal configuration.

18. The apparatus of claim 10, wherein the instructions are further executable by the one or more processors to cause the apparatus to:
identify a dynamic indication field of the physical downlink control channel, wherein the dynamic indication field indicates that a group of UEs in a group of the at least one UE is paged in a next paging occasion, the group of UEs comprising the UE.

19. A method for wireless communications at a user equipment (UE), comprising:
receiving, from a base station, a broadcast transmission comprising a reference signal configuration for communications between the base station and the UE while the UE is operating in a first mode, the reference signal configuration indicating one or more reference signal parameters and the first mode being either an idle mode or an inactive mode;
receiving one or more reference signals from the base station in accordance with the reference signal configuration while operating in the first mode;
determining one or more channel measurements based at least in part on the one or more reference signals received from the base station;
receiving, in a paging indicator of a physical downlink control channel (PDCCH), an indication of an availability of a reference signal of the one or more reference signals or an indication of an update to the reference signal configuration, wherein the PDCCH carries information for a group of at least one UE associated with a paging occasion; and
identifying a content field of the PDCCH, wherein a first bit of the content field indicates whether the UE is paged in a next paging occasion, and a second bit of the content field comprises the indication of the availability of the reference signal or the indication of the update to the reference signal configuration.

20. The method of claim 19, wherein one or more bits of paging downlink control information comprise the indication of the availability of the reference signal or the indication of the update to the reference signal configuration.
